(19) United States
(12) Patent Application Publication
(10) Pub. No.: US 2024/0406990 A1
(43) Pub. Date: Dec. 5, 2024

(54) COMMUNICATION APPARATUS AND COMMUNICATION METHOD FOR OPPORTUNISTIC WLAN SENSING

(71) Applicant: Panasonic Intellectual Property Corporation of America, Torrance, CA (US)

(72) Inventors: Rajat PUSHKARNA, Singapore (SG); Rojan CHITRAKAR, Singapore (SG); Hong Cheng, Michael SIM, Singapore (SG); Yoshio URABE, Nara (JP)

(21) Appl. No.: 18/688,201

(22) PCT Filed: Aug. 11, 2022
(86) PCT No.: PCT/SG2022/050573

§ 371 Date: Feb. 29, 2024

(30) Foreign Application Priority Data
Sep. 22, 2021 (SG) 10202110496T

(51) Int. Cl. H04W 72/542; H04L 5/00; H04W 72/563; H04W 84/12

(52) U.S. Cl. CPC H04W 72/542; H04L 5/0053; H04W 72/563; H04W 84/12

(57) ABSTRACT

Communication devices and methods for opportunistic WLAN sensing are provided. One exemplary embodiment provides a first communication apparatus comprising a 10 receiver, which in operation, receives a first PPDU and a second PPDU, the first PPDU indicating PHY parameters for the first PPDU and the second PPDU indicating PHY parameters for the second PPDU; and circuitry, which in operation, determines whether the PHY parameters of the first and second PPDUs are to be used for sensing based on a comparison between the first and second PPDUs, and the PHY parameters 15 of the first and second PPDUs.

### BACKGROUND

### 1. Technical Field

The present embodiments generally relate to communication apparatuses, and more particularly relate to methods and apparatuses for opportunistic wireless local area network (WLAN) sensing.

### 2. Description of the Related Art

In the standardization of next generation wireless local area network (WLAN), new radio access technology having backward compatibilities with IEEE 802.11a/b/g/n/ac/ax technologies has been discussed in the IEEE 802.11 Working Group and is named 802.11be Extremely High Throughput (EHT) WLAN.

P802.11bf PAR defines an amendment that enables a “MAC service interface for layers above the MAC to request and retrieve WLAN sensing measurements”. Physical Protocol Data Units (PPDUs) such as a null data PPDU (NDP) for sensing can be used for WLAN Sensing measurements.

Studies are underway on how to perform WLAN sensing procedure in an efficient manner. The details to be included in WLAN sensing procedure are still under discussion. Such details include:
How to reduce overhead such as that arising from the special sequence for WLAN Sensing (which exists even in threshold-based WLAN sensing);
When and how does a receiver forward the channel measurement result to upper layers (It may not be limited to opportunistic sensing and may also apply to NDPs if sensing-dedicated special sequence (such as NDPA for sensing) is not used);
How does a receiver know the transmit parameters which are necessary to perform the channel measurement;
How does a receiver know for which PPDU it should forward the channel measurement result to upper layers for opportunistic sensing;
If the PPDU is an NDP it can perform channel measurements and the results are forwarded up to the MAC, but this does not happen currently for PPDUs other than those for sounding. Therefore, how may a receiver be enabled to forward the channel measurement to upper layer in case of Regular PPDUs (e.g. if channel measurement is performed using NDP, the NDP is preceded by a NDPA frame based on which the receiver forwards the channel measurement result to the MAC, but this is not the case for other PPDUs); and
How to ensure that the format of Regular PPDU and transmit parameters when changed due to channel conditions do not impact the channel measurement result for opportunistic WLAN sensing; for example referring to illustration 600 of FIG. 6, channel conditions may have changed between the transmission of PPDU 602 and 604 due to beamforming 606 which may have been due to channel conditions or other factors which may affect channel measurement result calculated using PPDU 602 and that calculated from PPDU 604, wherein the PPDUs 602 and 604 may be NDP, data frames, beacons, or other similar frames.

However, there has been no discussion so far concerning opportunistic WLAN sensing.

There is thus a need for communication apparatuses and methods that can solve the above-mentioned issue. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for opportunistic WLAN sensing.

According to an aspect of the present disclosure, there is provided a first communication apparatus comprising: a receiver, which in operation, receives a first PPDU and a second PPDU, the first PPDU indicating PHY parameters for the first PPDU and the second PPDU indicating PHY parameters for the second PPDU; and circuitry, which in operation, determines whether the PHY parameters of the first and second PPDU are to be used for sensing based on a comparison between the first and second PPDUs, and the PHY parameters of the first and second PPDUs.

According to another aspect of the present disclosure, there is provided a second communication apparatus, comprising: circuitry, which in operation, generates a PPDU indicating a change in transmit parameters; and a transmitter, which in operation, transmits the PPDU to a first communication apparatus for performing channel measurement based on the PPDU and the indicated change in transmit parameters.

According to another aspect of the present disclosure, there is provided a communication method comprising: receiving a first PPDU and a second PPDU, the first PPDU indicating PHY parameters for the first PPDU and the second PPDU indicating PHY parameters for the second PPDU; and determining whether the first and second PPDU are to be used for sensing based on a comparison between the first and second PPDUs, and the PHY parameters of the first and second PPDUs.

It should be noted that general or specific embodiments may be implemented as a system, a method, an integrated circuit, a computer program, a storage medium, or any selective combination thereof. Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 illustrates an illustration of a WLAN Sensing process using a null data packet (NDP) according to an example.

FIG. 2 depicts an illustration of a High Efficiency (HE) Physical Protocol Data Unit (PPDU) frame format according to an example.

FIG. 3 depicts an illustration of various orthogonal frequency-division multiple access (OFDMA) PPDU formats according to an example.

FIG. 4 depicts an implementation of threshold-based feedback for WLAN sensing according to an example.

FIG. 5 depicts an implementation of threshold-based feedback for WLAN sensing according to another example.

FIG. 6 depicts an illustration of a channel measurement process according to an example.

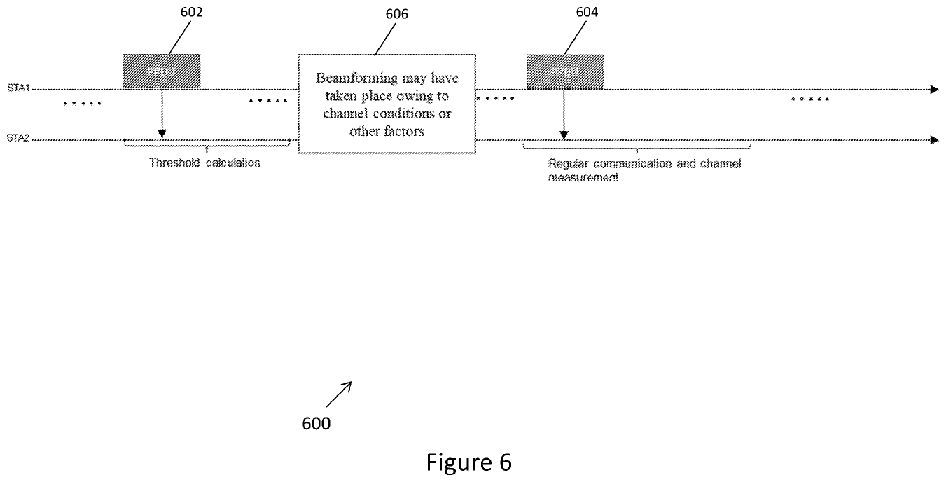

FIGS. 7A and 7B depict illustrations of how WLAN Sensing may be performed in accordance with an example.

FIG. 8 depicts an illustration of channel measurement using NDPs according to an example.

FIG. 9 depicts an illustration of a Station (STA) Info field format in an Extremely High Throughput (EHT) NDP announcement frame according to an example.

FIG. 10 depicts an illustration of a sensing trigger frame variant according to an example.

FIG. 11 depicts an illustration of a medium access control (MAC) filtering for received PPDU to be used for sensing according to an example.

FIG. 12 depicts an illustration of a Sensing NDP according to an example.

FIG. 13 depicts an illustration of a sensing process according to an example.

FIG. 14 depicts an illustration of a sensing process according to another example.

FIG. 15 depicts an illustration of opportunistic WLAN Sensing in accordance with various embodiments.

FIG. 16 depicts another illustration of opportunistic WLAN Sensing in accordance with various embodiments.

FIG. 17 illustrates an example of how a receiver STA can perform opportunistic WLAN sensing with a STA of interest and filter out PPDU from other STAs in accordance with a first embodiment.

FIG. 18 depicts an illustration of how a benchmark PPDU may be selected in accordance with a first embodiment.

FIG. 19 depicts an illustration of a sensing receiver operation in accordance with a first embodiment.

FIG. 20 depicts an illustration of a medium access control (MAC) primitive issued to physical layer (PHY) to extract CSI from the PPDU of interest.

FIG. 21 depicts another illustration of a sensing receiver operation in accordance with a first embodiment.

FIG. 22 depicts another illustration of a medium access control (MAC) primitive set by MAC to filter certain PPDUs so that physical layer (PHY) may automatically pass the CSI from filtered in PPDUs to the MAC.

FIG. 23 depicts an illustration of WLAN sensing using transmit beamforming sequence in accordance with a variation of the first embodiment.

FIG. 24 depicts an illustration of WLAN sensing using ranging sequence in accordance with another variation of the first embodiment.

FIG. 25 depicts an illustration of a WLAN sensing procedure in accordance with a second embodiment.

FIG. 26 depicts an illustration of opportunistic sensing support capability in WLAN sensing capability element in accordance with a second embodiment.

FIG. 27 depicts an illustration of a Tunneled Direct Link Setup (TDLS) Discovery Request frame that can be used to advertise opportunistic sensing capabilities in accordance with a second embodiment.

FIG. 27 further depicts an illustration of how TDLS Discovery Request and Response frames may be utilized for opportunistic sensing in accordance with a second embodiment.

FIG. 28 depicts an illustration of a sensing session in accordance with a second embodiment.

FIGS. 29 and 30 depict illustrations of a sensing session in accordance with a variation of the second embodiment.

FIG. 31 depicts an illustration of an example HE link adaptation (HLA) A-control field in accordance with a second embodiment.

FIG. 32 depicts an illustration of a channel measurement process adapted by the receiver to compensate for the change in transmit parameters in accordance with a second embodiment.

FIG. 33 depicts an illustration of an example WLAN Sensing Transmit (Tx) parameter indication frame in accordance with a second embodiment.

FIG. 34 depicts an illustration of how a transmitting STA indicates new parameters to a receiving STA in accordance with a second embodiment.

FIG. 35 depicts an illustration of an example threshold-based sensing procedure in accordance with a third embodiment.

FIG. 36 depicts an illustration of an example threshold-based sensing procedure using NDP in accordance with a third embodiment.

FIG. 37 depicts an illustration of an example sensing type Regular PPDU in accordance with a fourth embodiment.

FIG. 38 depicts an illustration of a sensing process using PPDUs that are periodically transmitted in accordance with a fifth embodiment.

FIG. 39 depicts a schematic diagram for a receiver in accordance with various embodiments.

FIG. 40 depicts a schematic diagram for a transmitter in accordance with various embodiments.

FIG. 41 shows a flow diagram illustrating a method for opportunistic WLAN sensing according to various embodiments.

FIG. 42 shows a schematic, partially sectioned view of a STA that can be implemented for opportunistic WLAN sensing in accordance with various embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the embodiments or the application and uses of the embodiments. Furthermore, there is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

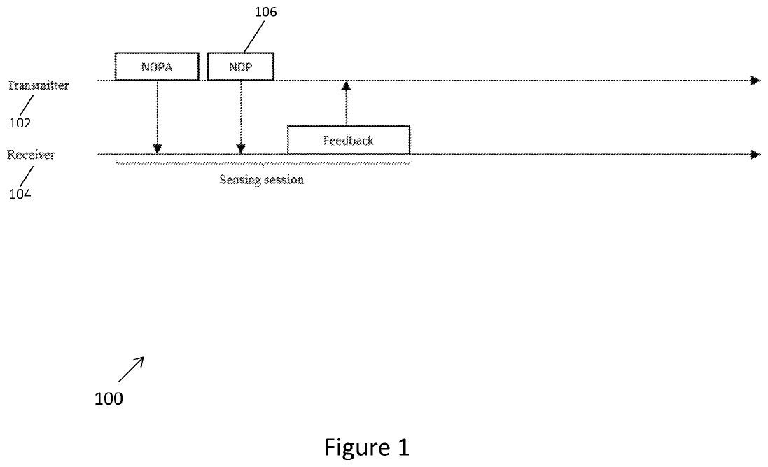

Overview of WLAN Sensing protocol is provided in IEEE contributions 21/504r1 (Specification Framework for TGbf, Claudio da Silva) and 20/1851r4 (Overview of Wi-Fi Sensing Protocol, Cheng Chen et. al.). Referring to FIG. 1, a NDP 106 may be used for WLAN sensing process 100 between a transmitter 102 and a receiver 104. The NDP 106 may be referred to as a Sensing NDP.

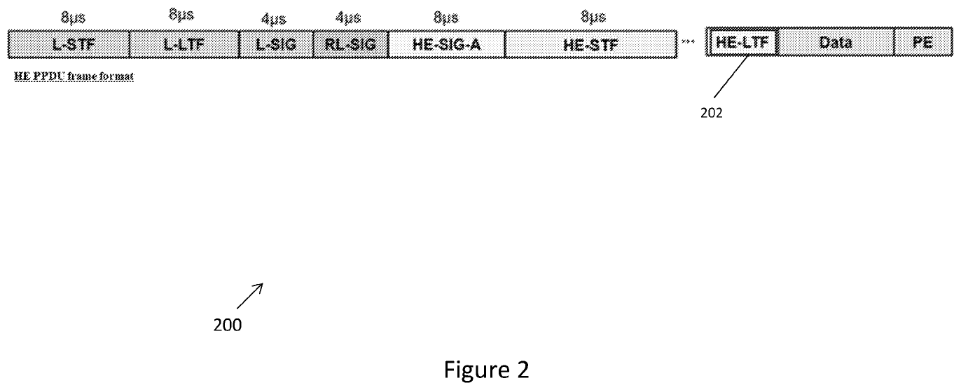

Multiple-input multiple-output (MIMO) channel measurement takes place in every PPDU as a result of transmitting long training fields (LTFs) as part of the PHY preamble. For example, referring to FIG. 2, HE-LTF field 202 of HE PPDU frame format 200 may be used for channel measurement.

A spatial mapping matrix specifies the type of spatial mapping used in a signal. The spatial mapping matrix is sometimes referenced as “Q matrix” in the IEEE 802.11n/ac/ax/be [2] standards. There are various types of Q matrix that may be used by a transmitter in a WLAN sensing process. A Q matrix is known as a direct map when an identity matrix is used by the transmitter. In direct map, each space-time stream is sent to only one transmitter antenna, and there is no interference between the space-time streams. A Q matrix may also be known as a Fourier matrix. The Fourier matrix mixes all space-time streams onto all select antennas and is commonly used when deploying operational transmitters.

In explicit beamforming, for a STA A to transmit a beamformed packet to a STA B, STA B measures the channel metrices and sends STA A either the effective channel H_{eff,k}, or a beamforming feedback matrix Vₖ, for STA A to determine a steering matrix Q_{steer,k}=QₖVₖ, wherein Qₖ is an orthonormal spatial mapping matrix that was used to transmit a sounding PPDU that elicited Vₖ, and Q_{steer,k} is defined as a mathematical term to update a new steering matrix for Qₖ in a next beamformed data transmission.

There were two types of beamforming feedback matrices, namely non-compressed beamforming feedback and compressed beamforming feedback. In the current specs (802.11ax), compressed beamforming feedback is implemented. A beamformer may use the compressed beamforming feedback to determine the steering matrices Qₖ.

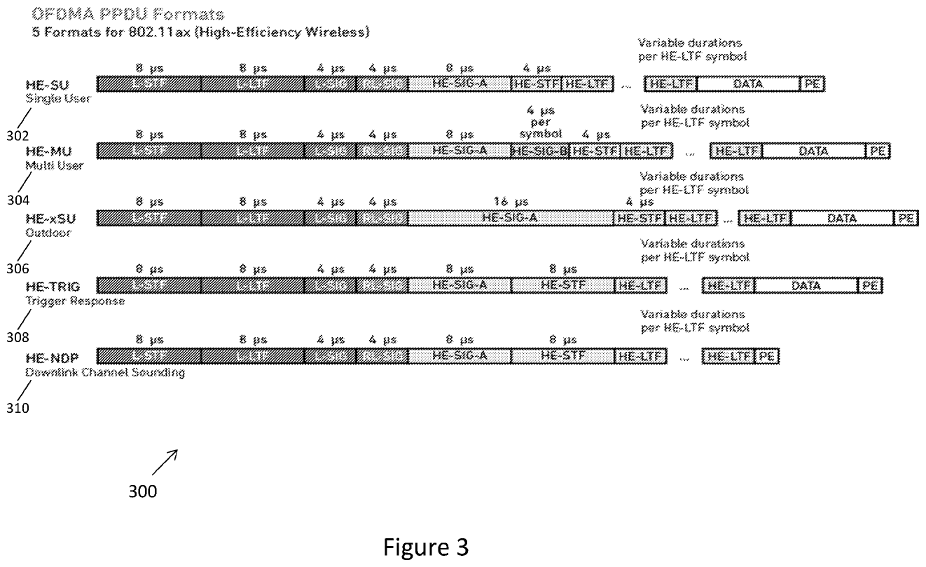

The format of a PPDU and transmission parameters may change based on channel conditions, neighbouring channel interference etc. As shown in illustration 300 of FIG. 3, 11ax itself has 5 different types of ODFMA HE PPDU formats, for example HE-Single User (HE-SU) 302, HE-Multiuser (HE-MU) 304, HE-Outdoor Single User (HE-xSU) 306, HE-Trigger Response (HE-TRIG) 308 and HE-NDP 310 for downlink channel sounding. Transmission parameters like Q matrix, number of LTFs in a PPDU, Modulation and Coding Scheme (MCS), bandwidth etc may depend on channel conditions and can vary.

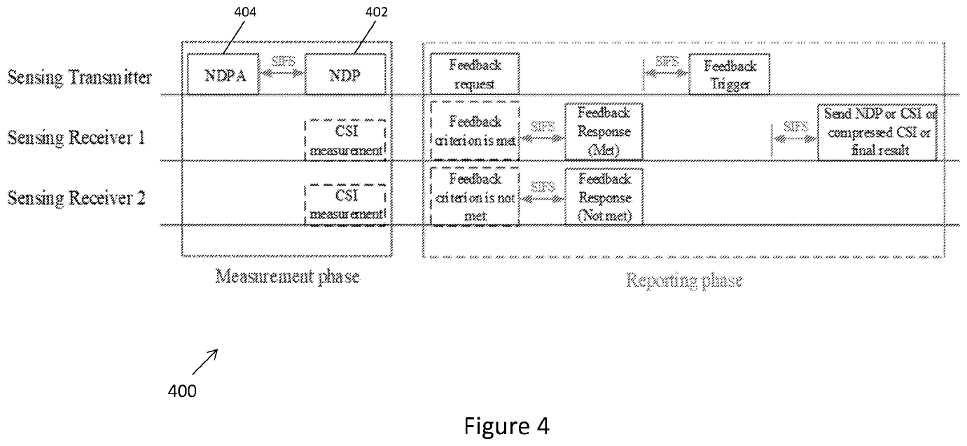

IEEE 802.11-21/1069 (Threshold-based Sensing Measurement Follow up (Huawei)) describes threshold-based feedback for WLAN sensing, which aims at reducing the overhead of transmitting feedback every time channel measurement is performed. For example, illustration 400 of FIG. 4 depicts an example WLAN sensing process with threshold-based feedback using NDP 402. Although threshold-based measurement reduces the number of times explicit feedback are being transmitted, it still uses a special sequence for WLAN Sensing (e.g., For channel measurement an NDPA 404 and NDP 402 needs to be transmitted just to check whether threshold has been crossed, which is still an overhead).

Task Group for WLAN sensing TGbf has proposed multiple ways by which WLAN Sensing can be performed, such as trigger-based (TB) sensing, non-TB sensing, NDP based sensing, etc (e.g., in IEEE 802.11-21/1015 Non-TB and TB measurement procedure for WLAN Sensing. (LGE)). There is also a possibility that WLAN Sensing can be performed based on Regular PPDUs, for example PPDUs other than PPDUs dedicated for sensing like sensing NDPs (such regular PPDUs maybe referred to as non-sensing PPDUs). Referring to FIG. 3, the various HE PPDU formats include data frames and NDP frames (e.g. HE-NDP 310). 802.11 specifications define LTFs (e.g. HE-LTF field in the various HE PPDU formats) as Long Training Fields which are used for channel estimation.

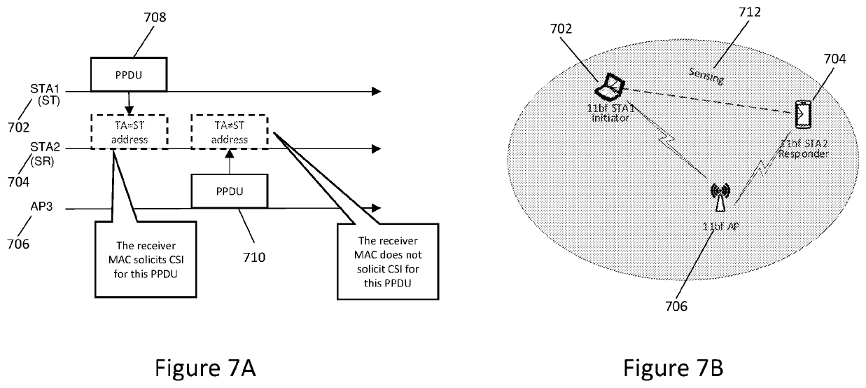

Although using NDP for WLAN Sensing has few advantages, it adds an overhead to ongoing communication as it needs transmission of special frames for sensing, such as the NDPA and NDP frame. It is possible using a regular PPDU to measure the channel with minimum or no overhead at all as these PPDUs will be transmitted for ongoing WiFi operations. A receiver (e.g. a receiving or receiver STA) may receive multiple PPDU(s) from a transmitter (e.g. a transmitting or transmitter STA), and processing channel state information (CSI) from all the received PPDU may unnecessarily take up system and computing resources. The receiver should also be able to filter out PPDU(s) which are not from the STA with which the receiver wants to perform WLAN sensing, for example as will be further illustrated and explained in FIGS. 7A and 7B.

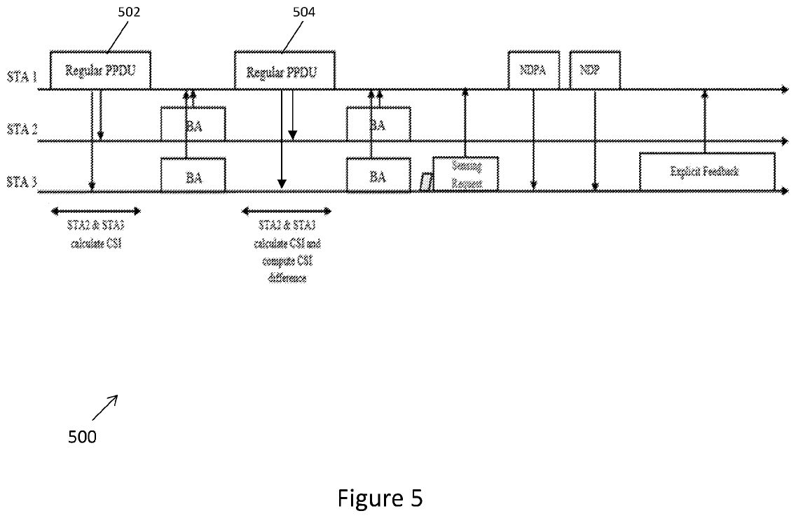

A STA may perform channel measurement based on regular PPDUs received from another STA to check whether a threshold has been crossed. If the threshold is crossed, the STA may perform a full channel measurement based on the LTFs in the received PPDU and may transmit an explicit feedback. For example referring to illustration 500 of FIG. 5, WLAN Sensing may be performed with non-sensing frames such as regular PPDUs 502 and 504 to further reduce overhead of NDPA and NDP transmission for threshold crossing detection. CSI (that is, the channel measured during training symbols of a received PPDU) is a type of sensing measurement result for sub-7 GHZ WLAN sensing, as discussed in IEEE 802.11-21/908 Sensing measurements: Interfaces and reporting (Intel, 908).

Opportunistic Sensing is defined as a procedure to perform WLAN Sensing using non-sensing PPDUs. WLAN Sensing can be opportunistically performed by the receiver by extracting the CSI from the LTFs of the received PPDU and the receiver's MAC issuing primitive to solicit the CSI to its MAC. Referring to FIGS. 7A and 7B, STA2 704 may be configured to calculate channel measurement results from PPDU 708 received from STA1 702 and PPDU 710 from AP3 706, but solicits the CSI result from the calculations to MAC only if the transmit address (TA) of the frame carried in the PPDU matches the TA of the sensing transmitter e.g. STA1 702 (with which STA2 704 is performing WLAN Sensing 712).

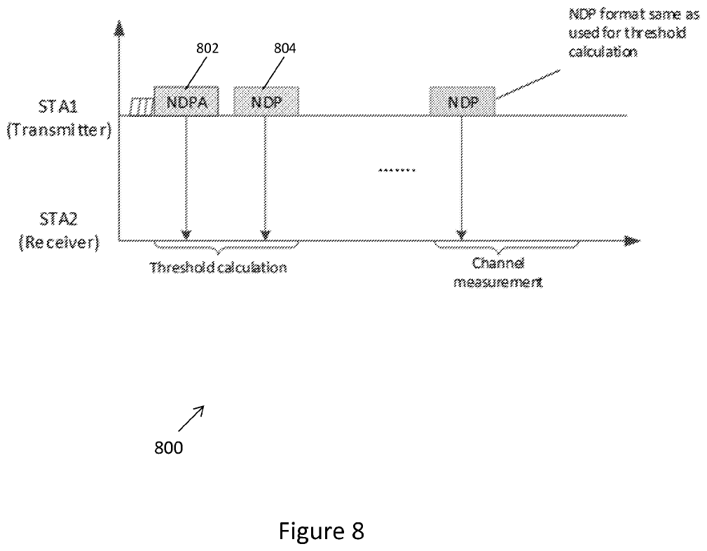

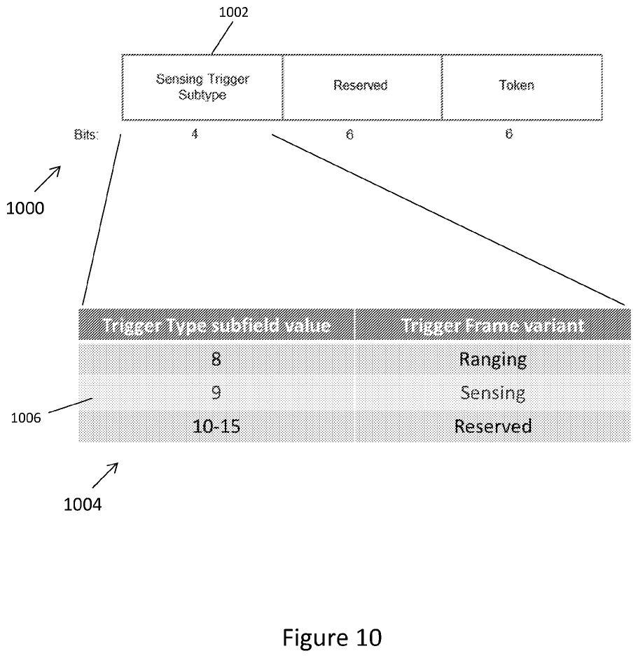

Generally, a NDPA frame would have an indication in the frame to inform whether the NDPA frame is a Sensing NDPA frame (and therefore also indicate whether a subsequently transmitted NDP frame is a Sensing NDP frame). Referring to illustration 800 of FIG. 8, NDP frame 804 is a Sensing NDP if NDPA frame 802 is a Sensing NDPA. A Sensing NDP frame may be transmitted following a Sensing NDPA frame or in response to a sensing trigger, for example the sensing trigger type variant as shown in illustration 1000 of FIG. 10. As far as PHY is not amended in sub-7 GHZ, a Sensing NDP may be the same format as one of existing NDPs, e.g. HT NDP, VHT NDP, HE NDP, HE Ranging NDP/HE TB Ranging NDP (including Ranging NDP with Secure HE-LTFs) or EHT NDP.

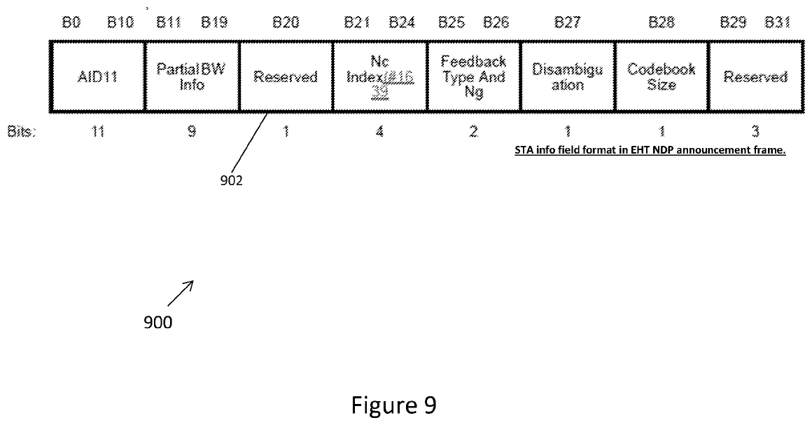

FIG. 9 depicts an illustration of a STA Info field format 900 in an EHT NDPA frame, which for example may be used in NDPA frame 802 of FIG. 8. Reserved bit 902 may be used to indicate whether an NDPA frame is a Sensing NDPA. For example, Reserved bit 902 may be set to 1 to indicate that this is a sensing NDPA, and the NDP following this will be a sensing NDP. Alternatively, a Sensing Trigger instead of an NDPA frame may be used, such as in the form of Sensing Trigger format 1000 of FIG. 10. In Sensing Trigger format 1000, Sensing Trigger Subtype field 1002 may be used to signal a Sensing Trigger frame subvariant (e.g. measurement poll, sounding, etc). For example, a trigger type subfield value of 9 (e.g. entry 1006 of table 1004) may be indicated in the Sensing Trigger Subtype field 1002 to signal that this is a Sensing Trigger frame.

Filtering of PPDU can be further extended (and may not be limited) to PPDU format for channel measurement. A receiver may choose PPDUs for which it will solicit the channel measurement result from PHY to MAC. The filtering can be based on one or more of the following:
The receiver may choose a minimum number of LTFs (or other PHY parameters, for example bandwidth, Tx power, etc.) which should be present in the PPDU for the receiver's MAC to solicit CSI to MAC layer.
The receiver may choose to solicit CSI to MAC only for a particular PPDU format. (For example, SU-PPDU).
The receiver may choose to solicit CSI to MAC only for PPDUs carrying a particular frame type. (For example, Data frames).

For frames which satisfy filtering rules of a sensing receiver, the MAC of the receiver may issue a PHY primitive PHY-CSI_RECEIVE.request (CSI_PARAMETER) to instruct PHY to pass up the collected sensing measurement to the MAC (e.g. in a PHY-CSI_RECEIVE.confirm(CSI_MATRIX) primitive) in cases where CSI is not passed up to the MAC layer. The main purpose of filtering the PPDU is to solicit CSI of PPDUs which are from a STA with which sensing is to be performed. Although, this does not help if Tx parameters change. To ensure that the format of PPDU remains the same during a sensing session, the transmitter may transmit the same PPDU format during the sensing session. This is, however, not an optimal solution as it will impact data transmission.

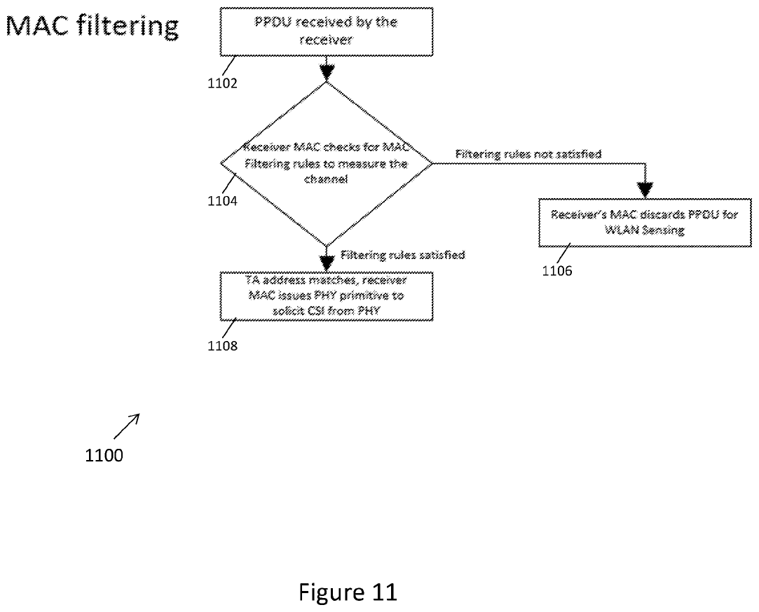

FIG. 11 depicts an illustration of a MAC filtering process 1100 according to an example. In step 1102, a PPDU is received by a receiver. In step 1104, the receiver checks for MAC filtering rules to select PPDU which passes through the filter to measure the channel. If the filtering rules are not satisfied by the received PPDU, the process proceeds to step 1106 where the receiver's MAC discards the PPDU for WLAN Sensing. Otherwise, if the filtering rules are satisfied, the process proceeds to step 1108 where, if the TA address matches, the receiver MAC issues a PHY primitive to solicit CSI from PHY.

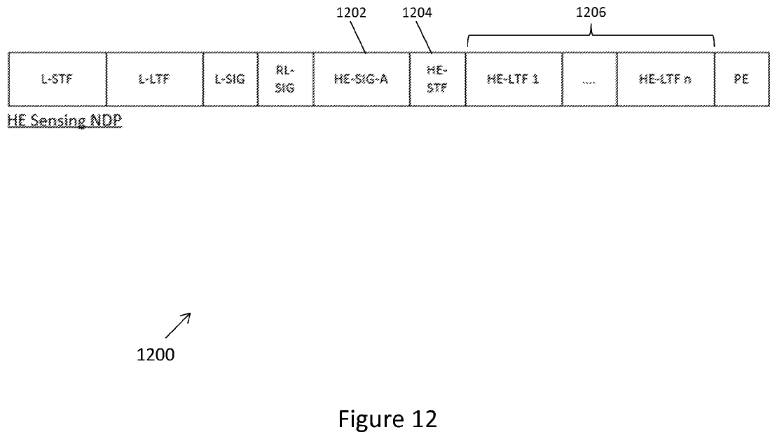

A problem of “how to ensure that the format of Regular PPDU and transmit parameters when changed due to channel conditions do not impact the channel measurement result for opportunistic WLAN sensing” may also be applied to a NDP for sensing as specific rules for ensuring the conditions are not defined. IEEE specs includes the rules for similar purposes. Applying such rules to “NDPs for sensing” may also be needed. For example, referring to FIG. 12, a Sensing NDP may be defined as an HE Sensing NDP 1200 as per following rules: No Q matrix is applied to the waveform; a Beamformed field in HE-SIG-A 1202 of the Sensing NDP 1200 is always set to 0; for transmission of HE-STF 1204 and HE-LTFs 1206, if N_{STS}=N_{Tx} the Q matrix shall be an identity matrix, and if N_{STS}<N_{Tx}, the Q matrix shall be based on an antenna selection matrix with no antenna swapping; further, the Q matrix becomes an Identity matrix when all ‘0’ elements are removed.

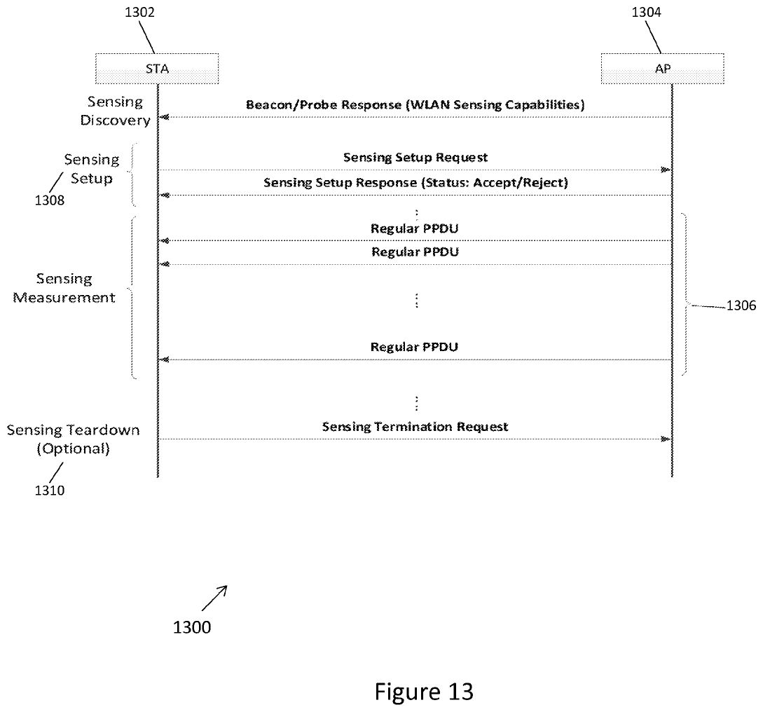

FIG. 13 depicts an illustration of a sensing process 1300 according to an example. Regular PPDUs 1306 transmitted from sensing transmitter AP 1304 to sensing receiver STA 1302 shall have the same Tx parameters for sensing during the sensing session e.g. after Sensing Setup 1308 until its termination at 1310 (either by explicit Sensing Teardown or implicit termination rules). If NDPs are transmitted during the sensing session, the NDPs may, in a first option, have the same Tx parameters as the regular PPDUs 1306. The sensing receiver STA 1302 may use both regular PPDUs and NDPs for sensing. In a second option, the NDPs may not have the same Tx parameters as the regular PPDUs 1306. The rule for NDPs may be the same as those described for Sensing NDP. The sensing receiver STA 1302 may use either regular PPDUs 1306 or Sensing NDPs. Alternatively, the sensing receiver STA 1302 may use regular PPDUs for sensing and use NDPs separately for another sensing.

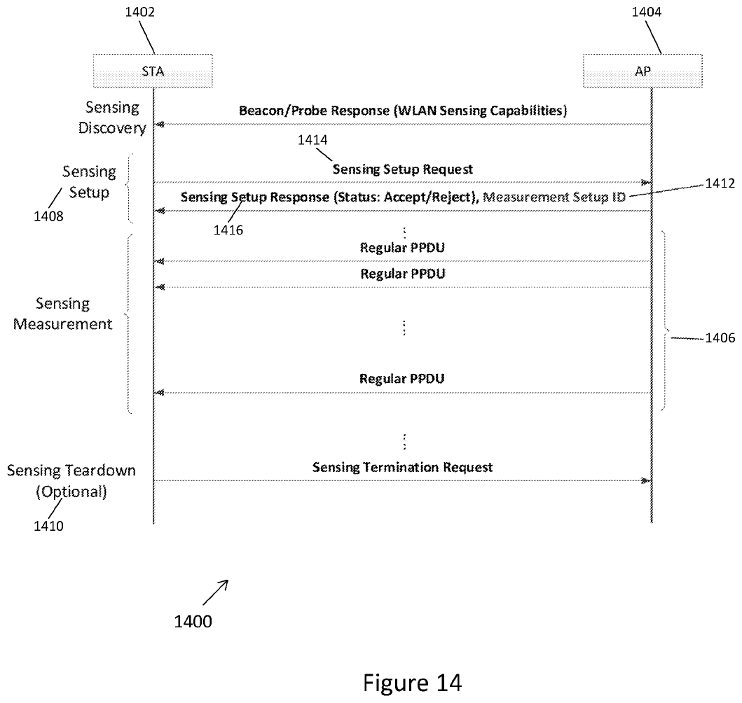

FIG. 14 depicts an illustration of a sensing process 1400 according to another example. While similar to sensing process 1300, a Measurement Setup ID 1412 is negotiated during Sensing Setup phase 1408. The Measurement Setup ID 1412 may be included in a Sensing Setup Request 1414 transmitted from sensing receiver STA 1402 to sensing transmitter AP 1404, or Sensing Setup Response 1416 transmitted from sensing transmitter AP 1404 to sensing receiver STA 1402. Regular PPDUs 1406 may also include a Measurement Setup ID in its payload, for example, in an A-control field in MAC frame carried in the PPDU. Sensing transmitter AP 1404 shall not include in the regular PPDUs 1406 a Measurement Setup ID with a same value as that of Measurement Setup ID 1412 if Tx parameters for sensing are different. By this rule, the sensing receiver STA 1402 can recognize that the PPDUs including a same Measurement Setup ID value as that of Measurement Setup ID 1412 have the same Tx parameters for sensing.

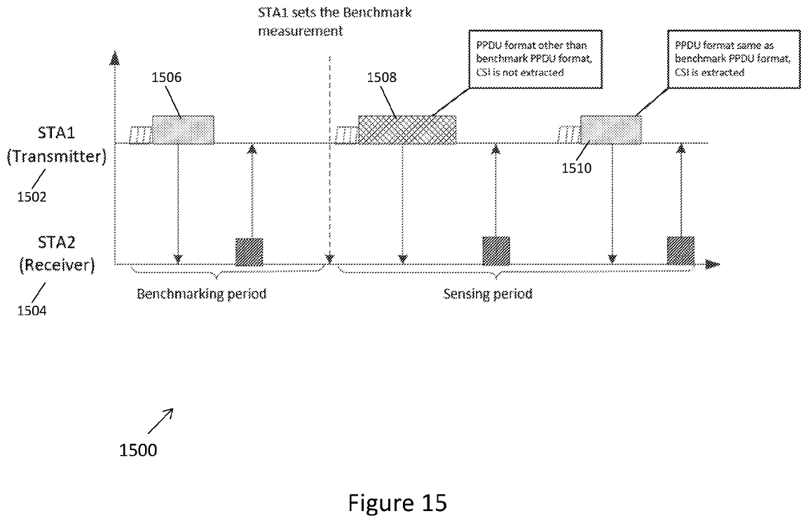

To address the various issues described above, various methods for opportunistic WLAN Sensing are proposed. Referring to illustration 1500 of FIG. 15, methods are proposed for a receiver STA2 1504 to perform opportunistic WLAN Sensing with no change in behaviour for regular WiFi operation. The receiver STA2 1504 upon receiving PPDU(s) from other STA(s) performs MAC filtering to filter out PPDU(s) from STA(s) other than from STA(s) with which the receiver wants to perform WLAN Sensing, for example PPDUs from transmitter STA1 1502. The receiver STA2 1504 receives PPDU of various formats during a period and selects a Benchmark PPDU format (e.g. PPDU 1506) to perform WLAN Sensing with PPDU of format same as the selected Benchmark PPDU 1506 to have consistent channel measurement. A Benchmark PPDU format can be defined as the PPDU format which is received a maximum number of times at the receiver STA2 1504 during a beacon interval or a last PPDU format received before the sensing session from the STA with which the receiver wants to perform sensing (e.g. transmitter STA1 1502). Filtering methods proposed in SPS can be used to filter out PPDUs other than Benchmark PPDU and Benchmark PPDU is used to extract benchmark measurement. Information from benchmark PPDU format like RSSI, Nsts, Ntx etc., may also be saved by the receiver STA2 1504.

If a received PPDU format is same as the benchmark PPDU format (e.g. PPDU 1508), the receiver performs normalized channel measurement on the received PPDU's channel measurement result (e.g. CSI is extracted from PPDU 1508) and benchmark measurement to minimise the impact of change in transmit parameters. Otherwise, if a received PPDU format is different from the benchmark PPDU format (e.g. PPDU 1510), CSI is not extracted. In normalized channel measurement, a subset of a matrix is extracted based on rank and order of a current channel measurement result (for example CSI matrix) and benchmark channel measurement result. The rank of a matrix refers to the number of linearly independent rows or columns in the matrix. If Q matrix is provided by the receiver STA2 1504, reverse channel may be calculated. The number of rows and columns that a matrix has is called its order or its dimension. By convention, rows are listed first; and columns, second.

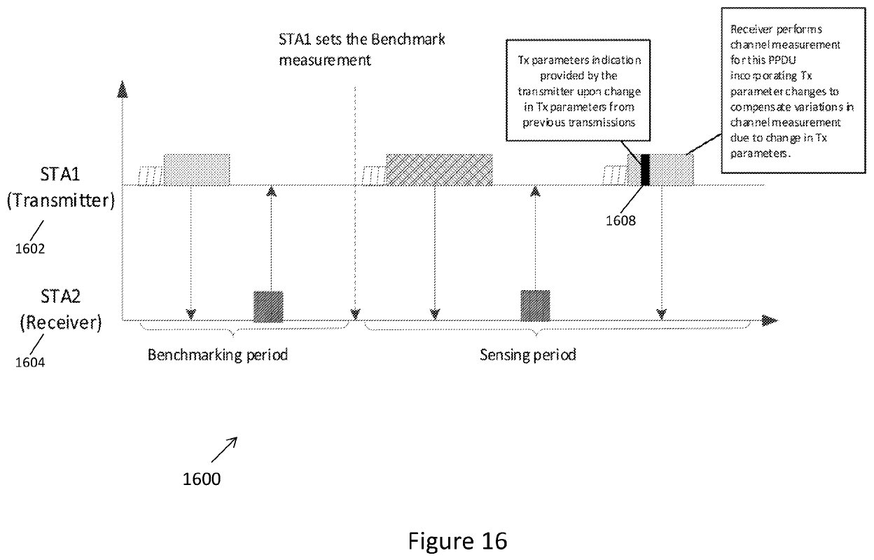

Referring to sensing process 1600 of FIG. 16, methods are also proposed for a receiver STA2 1604 to perform adaptations in channel measurement based on indication from a transmitter e.g. transmitter STA1 1602. The transmitter 1602 and receiver 1604 negotiate their opportunistic sensing capabilities. The transmitter 1602, upon changing the Tx parameters, will provide an indication of Tx parameter change 1608 in PPDU 1606 to the receiver 1604, the Tx parameter change indication 1608 indicating a change in Tx parameters from previous transmissions. Thereafter, the receiver 1604 upon receiving Tx parameter change indication 1608 from the transmitter 1602 may perform normalized channel measurement for the PPDU 1606, incorporating the Tx parameter change 1608 to advantageously compensate for variations in channel measurement e.g. due to change in Tx parameters.

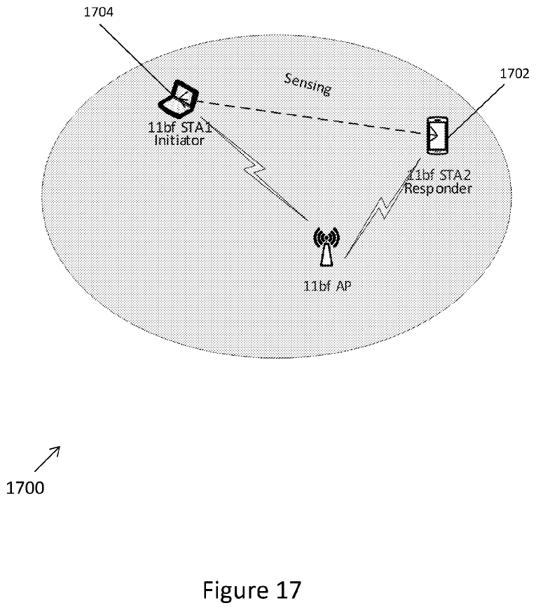

In a first embodiment, a receiver STA may perform WLAN Sensing based on its own capabilities from a PPDU received from STA(s) for which it wants to perform sensing. For example, referring to illustration 1700 of FIG. 17, STA2 1702 may perform MAC filtering to filter out PPDUs that are from STA(s) other than with which the STA2 1704 wants to perform sensing, and then selects a benchmark PPDU. WLAN Sensing is then to be performed between STA1 1704 and STA2 1702, the STA2 1702 being the opportunistic sensing capable STA.

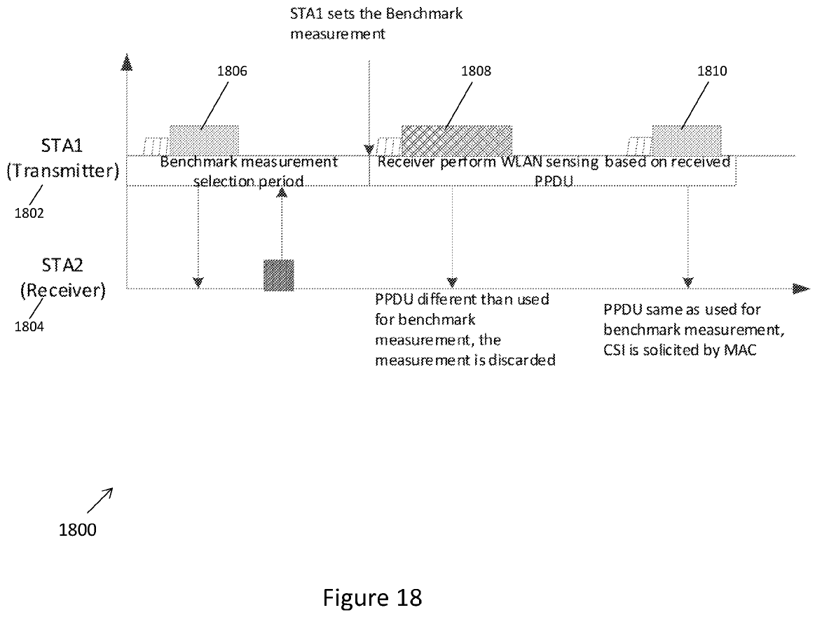

Further referring to illustration 1800 of FIG. 18, a benchmark PPDU (e.g. PPDU 1806 received from transmitter 1802) will result in ‘benchmark’ channel measurements (e.g. CSI matrix) which will be used to perform channel measurement subsequently. For example, receiver 1804 calculates a rank of the benchmark measurement (e.g. CSI matrix) and saves it. During channel measurement for WLAN sensing, the receiver 1804 computes the CSI for a received PPDU (e.g. PPDU 1810) if the format of the received PPDU is the same as that of the benchmark PPDU 1806, and compares the computed rank of the CSI matrix with the benchmark measurement's rank. Other, if it is determined that the received PPDU is different from the benchmark PPDU 1806 (e.g. PPDU 1808), then the PPDU 1808 is filtered out and the measurement obtained from PPDU 1808 is discarded.

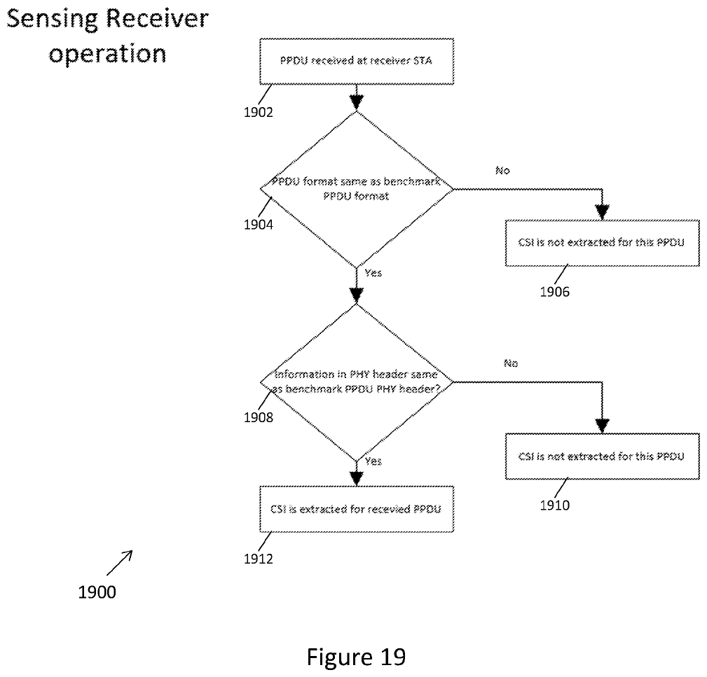

FIG. 19 depicts an illustration of a sensing receiver operation in accordance with the first embodiment. In step 1902, a PPDU is received at a receiver STA. In step 1904, it is determined if the received PPDU format is same as the benchmark PPDU format. If the format is different, the process proceeds to step 1906 wherein CSI is not extracted for the received PPDU. Otherwise, the process proceeds from step 1904 to step 1908 where it is determined if information in PHY header is same as that of the benchmark PPDU PHY header. If it is not determined to be the case, the process proceeds to step 1910 where the CSI is not extracted for the received PPDU. If it is determined to be the same, the process proceeds instead to step 1912 wherein the CSI is extracted for the received PPDU.

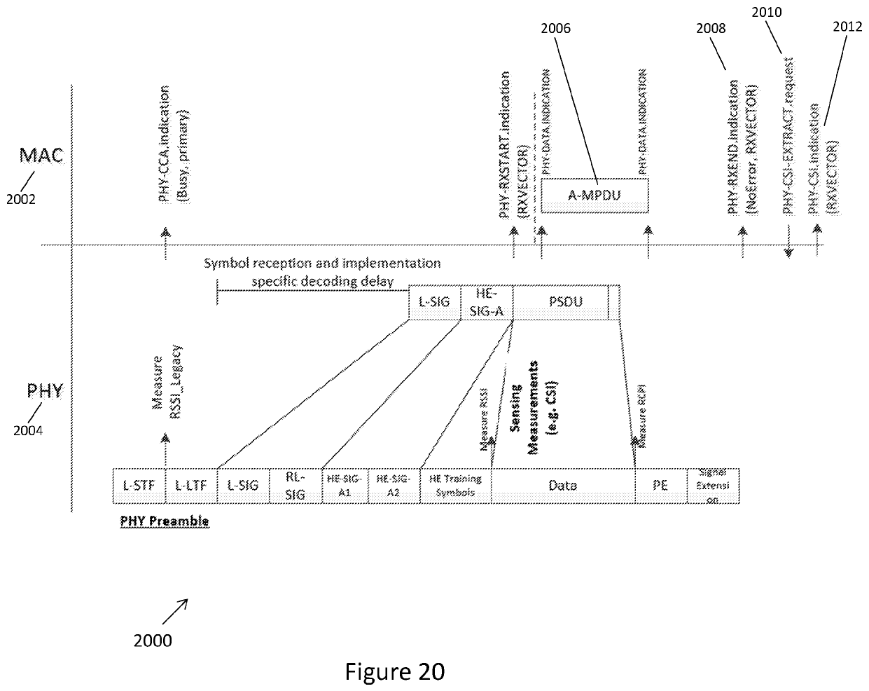

An example of PHY receive procedure for receiving sensing measurement (e.g., CSI) according to the first embodiment is shown in illustration 2000 of FIG. 20. MAC 2002 issues a PHY_CSI_EXTRACT.request primitive 2010 to PHY 2004 only after receiving a PPDU from which CSI is to be extracted (e.g. A-MPDU 2006) has been received by the MAC 2002 (e.g. after PHY-RXEND.indication 2008 is issued by the PHY 2004). After receiving the indication from the MAC, the PHY 2004 passes the CSI to the MAC 2002 using a new primitive PHY-CSI.indication (RXVECTOR) 2012.

For parameters like Q matrix etc., when the rank of the current channel measurement matrix remains the same as that of benchmark measurement, the receiver performs the following:
If the order of the matrix of current channel measurement is same as the order of benchmark measurement, the CSI is used for WLAN sensing.
If the current channel measurement results in a matrix of order higher than that of the benchmark measurement, the responder may extract a subset matrix from the current measurement based on the Tx chains and antenna selection pair (normalised measurement) and compare with the benchmark measurement.
If the current channel measurement results in a matrix of order lesser than that of the previous measurement, the CSI is used for WLAN sensing.
If the rank of the current channel measurement matrix is different than that of the benchmark measurement, the measurement is discarded.

Rank of a matrix may signify whether a change is in channel or Tx parameters. If the CSI matrix is changed due to channel variation, it will not result in change of rank. In the case of threshold-based measurement, benchmark measurement can be interchangeably used with threshold measurement.

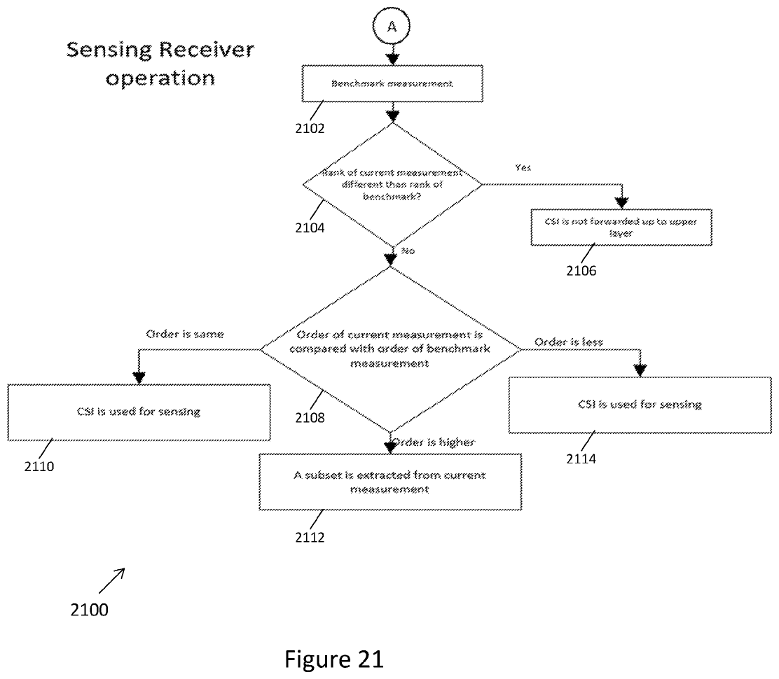

FIG. 21 depicts another illustration of a sensing receiver operation in accordance with the first embodiment. In step 2102, a sensing receiver performs benchmark measurement. This is after a benchmark PPDU is selected and a subsequent PPDU matches the benchmark PPDU. In step 2104, it is determined whether rank of a current measurement is different from rank of the benchmark measurement. If rank of a current measurement is different from rank of the benchmark measurement, it means there is change in Tx parameters. If it is determined to be the case, the process proceeds to step 2106 where CSI is not forwarded to the upper layer. Otherwise, the process proceeds from step 2104 to step 2108 where order of current measurement is compared with order of the benchmark measurement. If it is determined that the order of the current measurement is the same or less than the order of the benchmark measurement, the process proceeds to step 2110 or step 2114 respectively, wherein CSI is used for sensing. On the other hand, if it is determined in step 2108 that the order of the current measurement is higher than the order of the benchmark measurement, the process proceeds to step 2112 wherein a subset is extracted from the current measurement (normalised channel measurement).

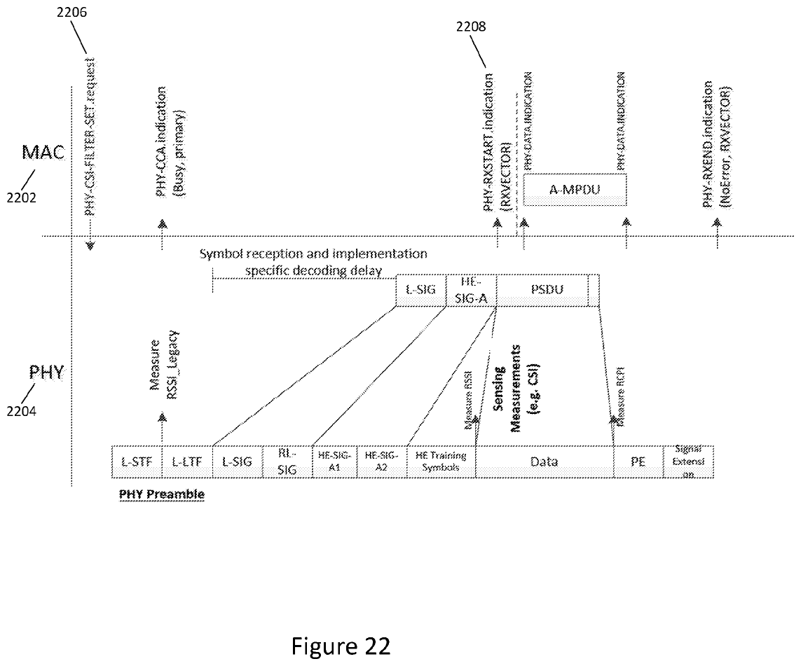

In another option, referring to illustration 2200 of FIG. 22, instead of MAC 2202 performing CSI extraction for every PPDU that matches the benchmark format, the MAC 2202 can set a PPDU filter (for at least some if not all parameters) on the PHY 2204 e.g., using a PHY-CSI-FILTER-SET.request primitive 2206. This advantageously enables the PHY 2204 to perform the PPDU filtering itself, and if the PPDU passes the filter, the PHY 2204 can autonomously pass the CSI to the MAC 2202 perhaps within the same RXVECTOR in PHY-START.indication (e.g., using PHY-RXSTART.indication (RXVECTOR) primitive 2208) that is used to indicate a start of a Data portion. An important change to the RXVECTOR though is that the CHAN_MAT primitive is present even if PSDU_length is >0.

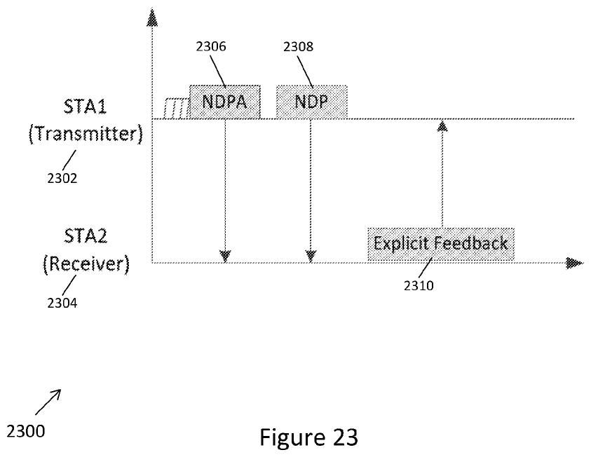

In a variation of the first embodiment, another option for receiver to perform opportunistic sensing is via transmit beamforming sequence. Referring to illustration 2300 of FIG. 23, receiver STA2 2304 can perform opportunistic sensing based on transmit beamforming performed between the receiver STA2 2304 and the STA with which it wants to perform channel measurement e.g. transmitter STA1 2302. If NDPA 2306 is addressed to the STA performing opportunistic sensing, the STA may save the CSI it calculated using NDP 2308. Further, if the NDPA 2306 is addressed to other STA(s) instead, the CSI can be extracted from explicit feedback 2310.

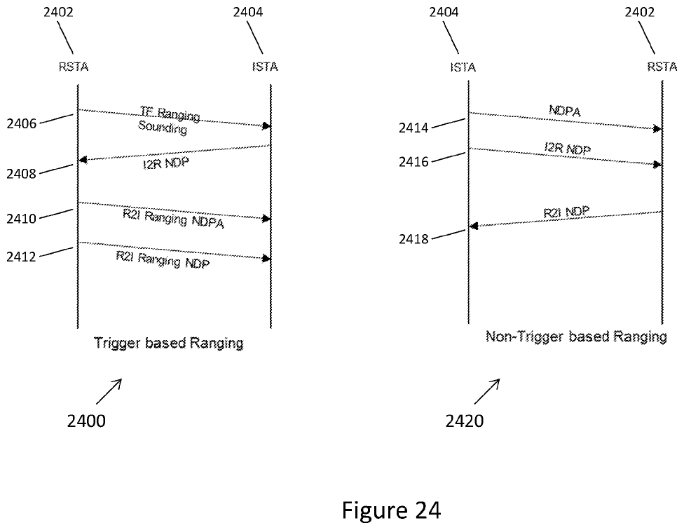

In another variation of the first embodiment, 802.11az (Ranging) sequence may also be used for WLAN Sensing. In this case, sensing may be performed even if the other STA supports only 11az and does not support 11bf. If both STAs support 11az and 11bf, ranging and sensing may be performed at the same time. For example, referring to illustration 2400 of FIG. 24, trigger based ranging 2400 or non-trigger based ranging 2420 may be used for WLAN sensing between a responder STA (RSTA) 2402 and initiator STA (ISTA) 2404. In this setup, NDP may be used for sensing (e.g. I2R NDP 2408 and 2416, R2I Ranging NDP 2412 and R2I NDP 2418). Trigger frame (e.g. TF Ranging Sounding frame 2406) and NDPA (e.g. R2I Ranging NDPA and NDPA 2414) may be modified to support sensing if both responder RSTA 2402 and initiator ISTA 2404 also support WLAN Sensing capabilities.

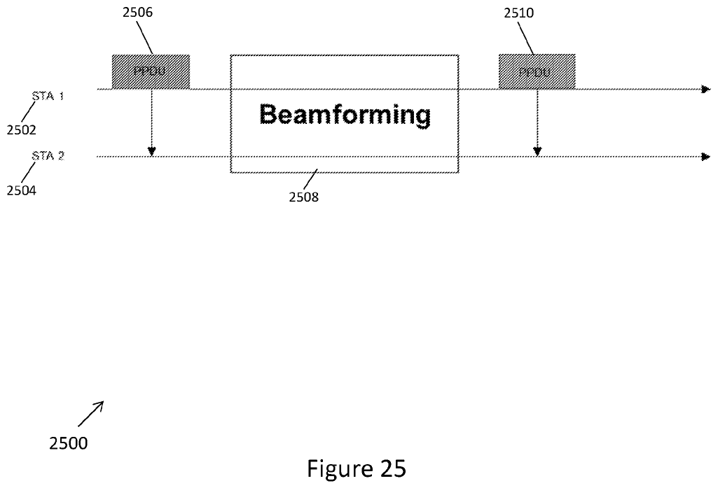

According to a second embodiment, for WLAN sensing to be accurate and reliable, it is important that the transmitter shall indicate a change in Tx parameters for the receiver to know that the variation in channel measurement is due to change in Tx parameter and not because of change in channel conditions. For example, referring to illustration 2500 of FIG. 25, PPDU 2510 transmitted after beamforming 2508 may be different from PPDU 2506 before beamforming because of factors such as change in Tx parameters, change in channel, etc. Transmitter STA1 2502 may indicate any change in Tx parameters to receiver STA2 2504, but for the receiver STA2 2504 to understand such indications, a negotiation is necessary between the receiver 2504 and transmitter 2502.

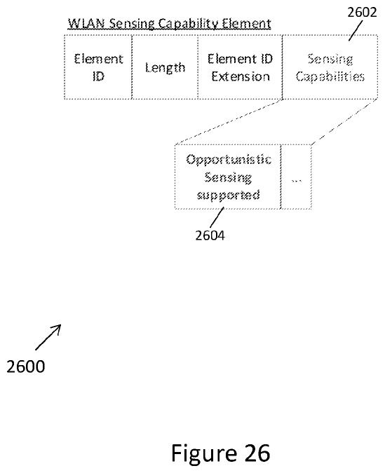

Referring to FIG. 26, a STA which supports opportunistic WLAN Sensing may indicate such support in its sensing capabilities field 2602 in a WLAN Sensing capabilities element 2600, for example using a 1-bit indication 2604 to indicate that opportunistic sensing is supported. Discovery for opportunistic WLAN Sensing supported STA can be performed as one or all the following method(s):
An AP may advertise its opportunistic WLAN sensing capabilities using WLAN Sensing capability element in beacons, probe response frames, association response frame, FILS discovery frame, etc;
A non-AP STA may advertise its opportunistic WLAN sensing capabilities by including the WLAN Sensing Capability element in frames such as probe request frame, association request frame, etc.

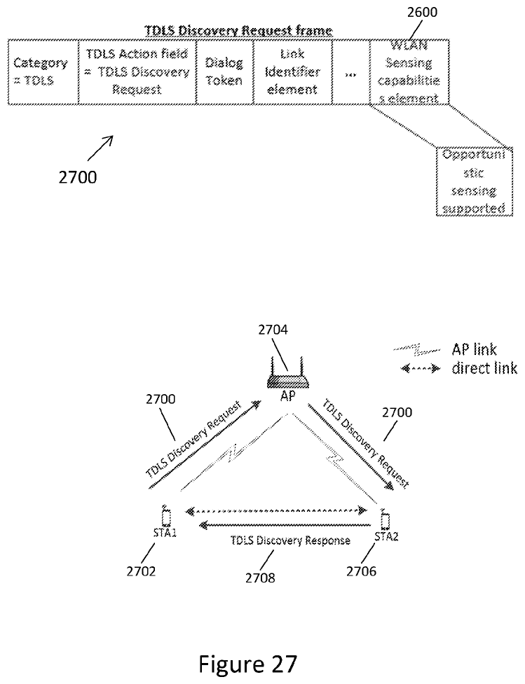

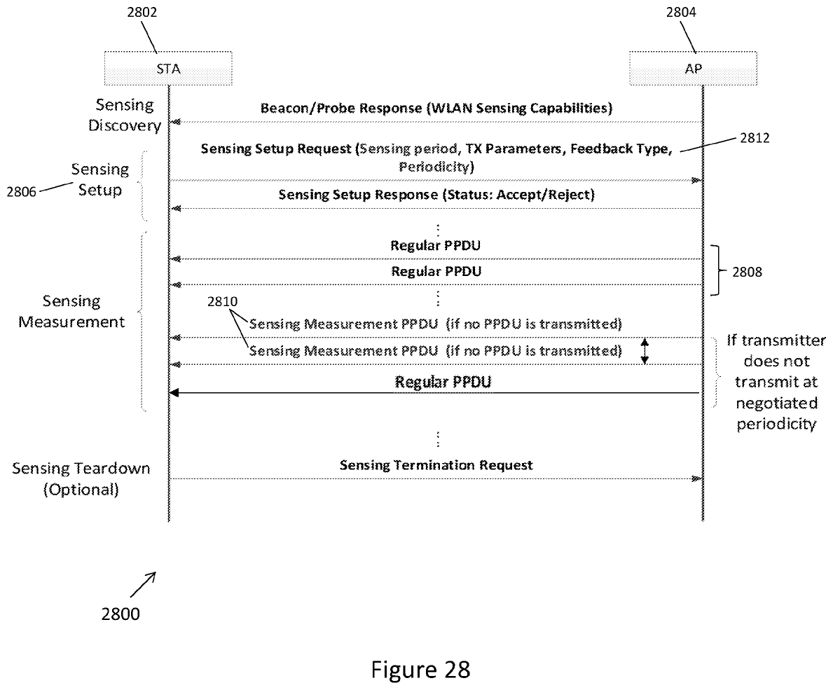

A non-AP STA may determine if other non-AP STA in a BSS associated with the same AP support the opportunistic WLAN Sensing capabilities through TDLS. For example, referring to FIG. 27, the WLAN Sensing capability element 2600 may be carried in a TDLS Discovery Request/Response frame (e.g. TDLS Discovery Request frame 2700 transmitted via AP 2704 from STA1 2702 to STA2 2706) and TDLS Discovery Response frame 2708) or TDLS Setup request/response frames. After discovering the capabilities STA go on to setup TDLS link. For example, the sensing setup is performed directly between the STAs and PPDUs that are transmitted on the direct path are used for opportunistic sensing.

After an opportunistic WLAN sensing capable STA is discovered, the initiator sends a sensing request to another opportunistic WLAN sensing capable STA. The negotiation also benefits in setting up periods during which WLAN sensing will be performed opportunistically. Opportunistic sensing can also be performed between an opportunistic WLAN sensing capable AP and its associated opportunistic WLAN Sensing capable STA(s) in the scheduled SPs. The parameters negotiated may be:
Sensing period: For which the PPDU will be used for WLAN Sensing.
Tx Parameters: Tx power, bandwidth, PHY format, etc.
Periodicity: To meet the required performance, a periodic transmission shall be negotiated. For example, as WiFi traffic is bursty in nature, it is possible that at times during a sensing session the transmitter has no PPDU to transmit. In such cases, the transmitter transmits a PPDU to the receiver at negotiated periodicity (say 10 ms) during the sensing session. The PPDU may or may not carry a payload.

For example, in WiFi it is observed that traffic is bursty in nature, if during the period specified for which opportunistic WLAN Sensing shall be performed there is no PPDU being transmitted, the transmitter shall transmit NDPs, etc. at the specified transmission rate.

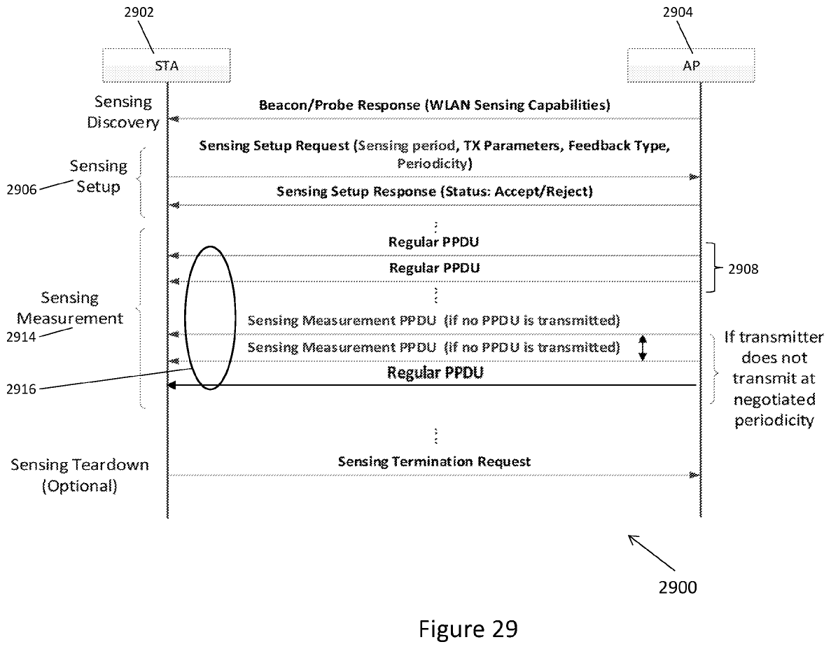

FIG. 28 depicts an illustration of a sensing session 2800 in accordance with the second embodiment. During Sensing Setup 2806, Setup Request 2806 transmitted from STA 2802 to AP 2804 may include request for various parameters such as sensing period. Tx parameters, feedback type, Measurement ID and periodicity. There may be various regular PPDUs 2808 during the sensing session which have different Tx parameters (e.g. PPDUs for Control frames or Management frames may use different Tx parameters from PPDUs for Data frames). A kind of ID can be used to identify PPDUs which have the same Tx parameters, e.g. a setup ID is included in “sensing A-control field” if the PPDU is intended to be used for the sensing session. Further, Sensing Measurement PPDUs 2810 under the setup for an opportunistic sensing shall have the same Tx parameters as the previous regular PPDUs 2808 in the same session of the sensing setup.

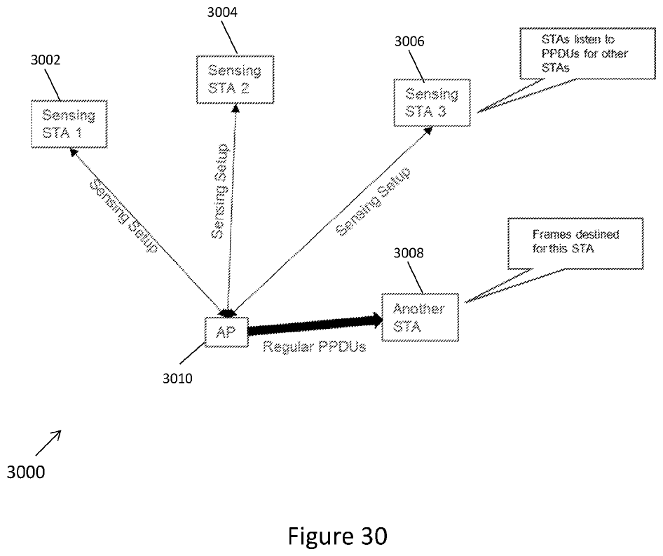

FIGS. 29 and 30 depict illustrations 2900 and 3000 respectively of a sensing session in accordance with a variation of the second embodiment. In this variation, all frames 2916 transmitted during Sensing Measurement 2914 may be directed to another STA instead of STA 2902. Sensing STA 2902 may use regular PPDUs 2908 destined to other stations, for example referring to FIG. 30 wherein Sensing STAs 3002, 3004 and 3006 may listen to PPDUs for other STAs, such as frames destined from AP 3010 to another STA 3008. In that case, the Sensing Setup 2906 is performed between the sensing STA 2902 and the AP 2904 for the traffic from the AP 2904 to another STA. The sensing setup may advantageously allow such configuration for increased benefit of opportunistic sensing. The STA 2902 may indicate to the AP 2904 that it may listen to PPDU transmitted to another STA during sensing setup 2906.

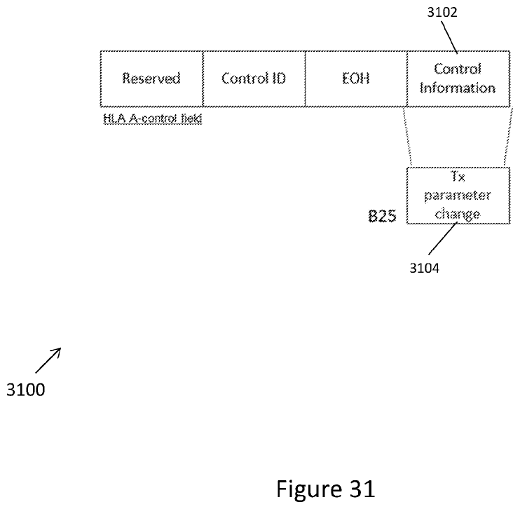

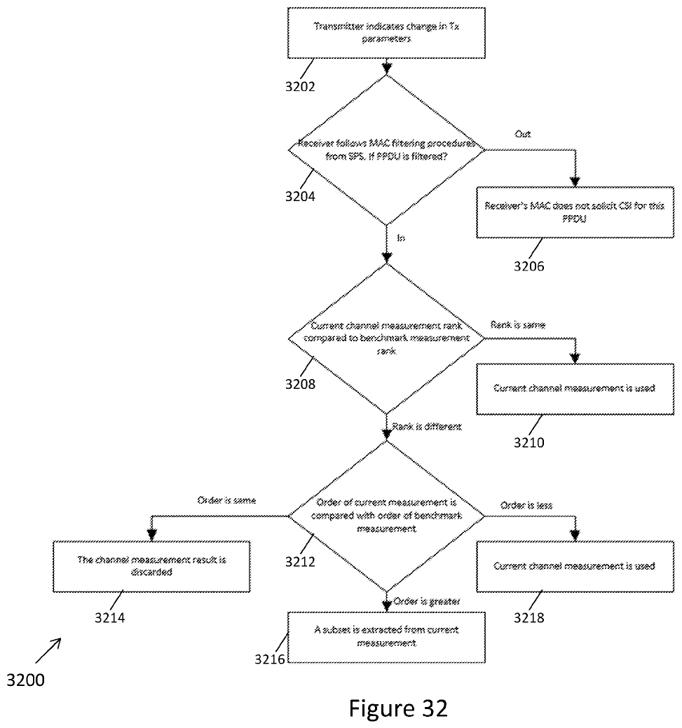

According to the second embodiment, a transmitter after beamforming or changing the Tx parameters shall indicate to a receiver about changes in transmit parameters (if any) using a one-bit indication in an HE link adaptation (HLA) A-control field. FIG. 31 depicts an illustration of an example HLA A-control field 3100 in accordance with the second embodiment. The one-bit indication may be provided via bit B25 3104 in Control Information field 3102 of the HLA A-control field 3100. Alternatively, a new A-control field e.g., ‘sensing A-control field’ may also be defined to indicate the parameters to a receiver. Upon receiving the indication of change in transmit parameters from the transmitter, the receiver may perform channel measurement as shown in channel measurement process 3200 of FIG. 32.

Channel measurement process 3200 starts from step 3202, wherein a transmitter indicates change in Tx parameters to a receiver. In step 3204, the receiver follows MAC filtering procedures from SPS, and it is determined if a received PPDU is filtered. If the received PPDU is filtered out, the process proceeds to step 3206 where the receiver's MAC does not solicit CSI for the received PPDU. Otherwise, the process proceeds to step 3208 instead, where current channel measurement rank is compared to benchmark measurement rank. If it is determined that the compared ranks are the same, the process proceeds to step 3210 where the current channel measurement is used. If it is determined that the compared ranks are different, the process proceeds to step 3212 where order of current measurement is compared with order of benchmark measurement. If it is determined that the order of current measurement is the same as the order of the benchmark measurement, the process proceeds to step 3214 where the channel measurement result is discarded. If it is determined that the order of current measurement is greater than the order of the benchmark measurement, the process proceeds to step 3216 where a subset is extracted from the channel measurement. If it is determined that the order of current measurement is less than the order of the benchmark measurement, the process proceeds to step 3218 where the current channel measurement is used for sensing.

If threshold-based WLAN sensing is implemented, the receiver may choose to perform threshold detection as follows when Tx parameter change bit is set to 1 but ranks are different:
If the order of the matrix of current channel measurement is same as the order of benchmark measurement, the receiver may discard the measurement result.
If the current channel measurement results in a matrix of order higher than that of the benchmark measurement, a subset of the current channel measurement shall be extracted based on the Tx chains and antenna selection pair used to compare with the threshold. This subset is termed as a normalised channel measurement and can be compared against threshold to determine threshold crossing.
If the current channel measurement results in a matrix of order lesser than that of the previous measurement, the current channel measurement is used for sensing.

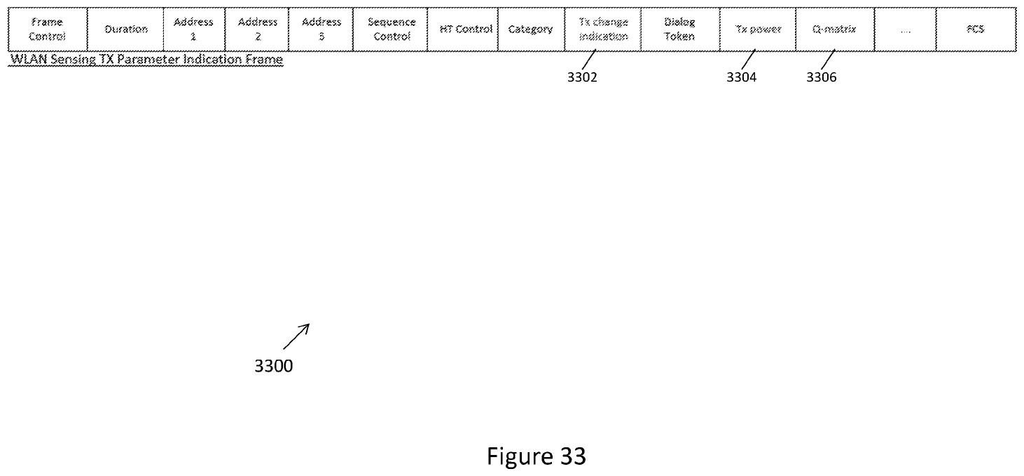

A new management frame e.g., WLAN Sensing Tx parameter indication frame 3300 of FIG. 33 can be defined which may be transmitted by a transmitter upon change in Tx parameters. WLAN Sensing Tx parameter indication frame 3300 may comprise a Tx change indication field 3302 for indicating a change (if any) in Tx parameters, Tx power field 3304 for indicating Tx power for the channel, and Q-matrix field 3306 for indicating a Q-matrix that is applied by the transmitter. The transmitter may transmit the WLAN Sensing Tx parameter indication frame 3300 when it adapts the Tx parameters based on beamforming or channel conditions, etc. The frame may be transmitted just after the transmitter changes the Tx parameters.

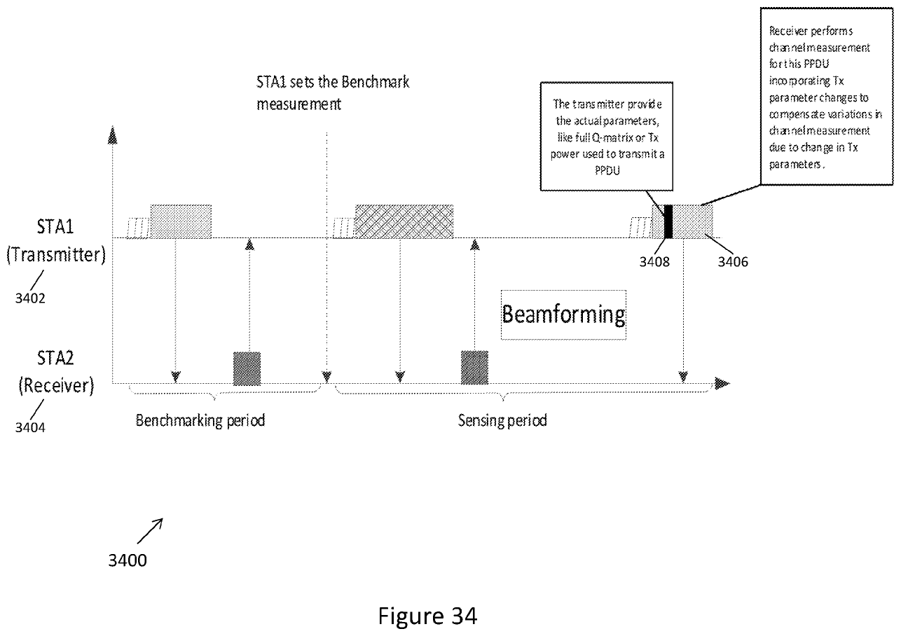

A transmitting STA upon performing parameter change may indicate the new parameters using the WLAN Sensing Tx parameter indication frame 3300. Further referring to illustration 3400 of FIG. 34, transmitter STA1 3402 may inform receiver STA2 3404 of actual Tx parameters (like Q matrix, Tx power, etc.) 3408 which the transmitter STA1 3402 has changed for transmission. Upon receiving the new Tx parameters from the transmitter STA1 3402, the receiver STA2 3404 may perform channel measurement for PPDU 3406 with indication and take the inverse of the received Q matrix and multiply it with the current channel measurement matrix to obtain the channel prior to Q matrix change (calculated channel measurement). If the rank of calculated channel matrix and rank of benchmark measurement are different from each other, the channel measurement result is passed to the upper layer or initiator. If parameters such as the Tx power change from a previous transmission, the transmitter may indicate the change in Tx power from previous transmission to current transmission in the WLAN Sensing Tx parameter indication frame. If the change is more than an optimal sensing power in subsequent PPDUs, the CSI is not extracted from the received PPDU 3406. Optimal sensing power may be defined as 50% of full transmit power (e.g., such as 100 mW at 2.4 GHz). This may be negotiated during sensing setup and can be application specific. If Tx power is known to the receiver, the difference between current Tx power and benchmark Tx power is calculated and if the current channel matrix per element varies, it is assumed that there is a change in channel parameters.

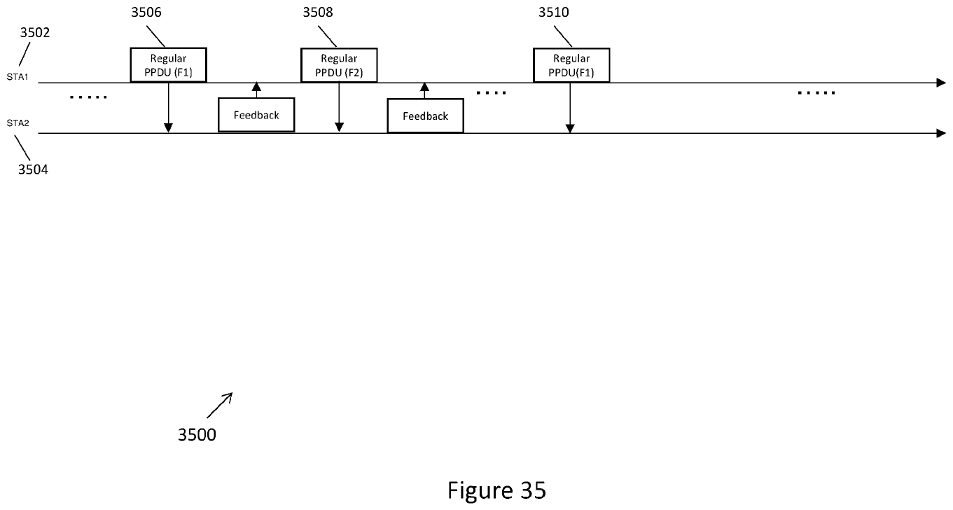

According to a third embodiment, for threshold-based sensing, an initiator may calculate multiple thresholds with different PPDU formats and indicate a threshold to a responder, such that the threshold corresponds with a PPDU format that is compatible with the particular responder. Based on different PPDU formats, the initiator can calculate different thresholds corresponding to the PPDU format and indicate the same using a ‘WLAN Sensing Threshold’ element. The WLAN Sensing threshold element can be carried in broadcast/unicast frames (implementation specific). To set the threshold for a group of STAs, broadcast frames such as beacons, probe response frames etc, can be used. For setting threshold for individual STA, a new management frame can be used, such as a Sensing Request frame. Referring to illustration 3500 of FIG. 35, each of PPDUs 3506 and 3508 transmitted from initiator STA1 3502 to responder STA2 3504 are of different PPDU formats that may be used in threshold calculation for threshold-based sensing. STA2 3504 may use a threshold that corresponds to a PPDU format that is compatible with STA2 3504 e.g. in this case, it is a threshold corresponding to PPDU format of PPDU 3506. As a result, PPDUs that have a PPDU format corresponding to PPDU 3506 (e.g. PPDU 3510) are then filtered based on the threshold to be used for sensing.

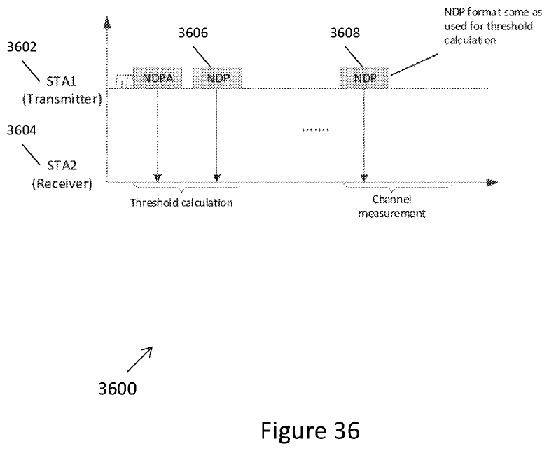

FIG. 36 depicts an illustration of an example threshold-based sensing procedure 3600 using NDP in accordance with the third embodiment. To maintain a same format of NDP during threshold calculation and threshold measurement, transmitter STA1 3602 may save the format of NDP 3606 (e.g., number of LTFs in the NDP, PPDU format like HT/VHT etc.) used for threshold calculation and use the same format for threshold crossing detection during actual channel measurement. Therefore, a next NDP 3608 having the same format as NDP 3606 may advantageously be used for threshold calculation.

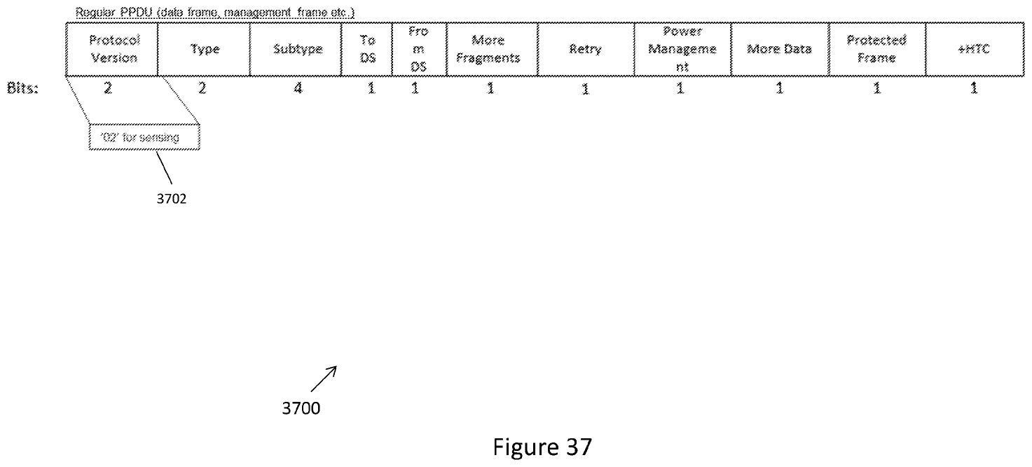

According to a fourth embodiment, when a transmitter changes any of the Tx parameters for a receiver to perform channel measurement accordingly, the transmitter may provide an indication using one reserved bit. This indication is to be carried in the frame carried by a PPDU after beamforming. If this indication is enabled, the PPDU is used as benchmark PPDU. FIG. 37 depicts an illustration of an example Regular PPDU frame 3700 in accordance with the fourth embodiment. Protocol Version ‘02’ 3702 can be used by the transmitter to indicate to the receiver that Regular PPDU 3700 can be used for sensing. The indication may be carried in the MAC header for data frames, management frames etc. For example, the indication may be carried in frames transmitted just after beamforming.

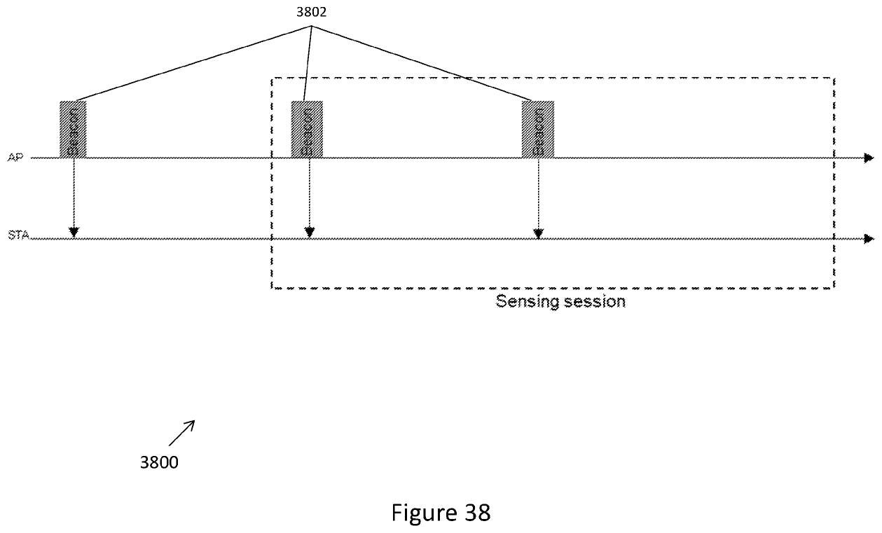

According to a fifth embodiment, opportunistic sensing/threshold detection can also be performed using frames that are periodically transmitted such as, for example, beacons 3802 as shown in sensing process 3800 of FIG. 38. A condition is that during the sensing session, the AP capable of opportunistic sensing should not change the transmit parameters for which sensing is performed. The AP may announce intervals during which the Tx parameters will remain constant such as, for example, target wait time (TWT) intervals for sensing, etc.

Thus, opportunistic WLAN Sensing may be based on a receiver's capabilities without involvement of a transmitter or involving Tx parameter change indication from a transmitter. Further, opportunistic WLAN Sensing may involve MAC filtering rules for a receiver, PPDU benchmarking for selecting a particular PPDU format for WLAN Sensing, 1-bit indication from a transmitter wherein a receiver performs channel measurement to advantageously compensate for Tx parameter change indicated by the 1-bit indication, a transmitter indicating new Tx parameters using a management frame, and/or multiple thresholds calculated for different PPDU formats to advantageously minimise the impact of change in PPDU format for threshold-based sensing.

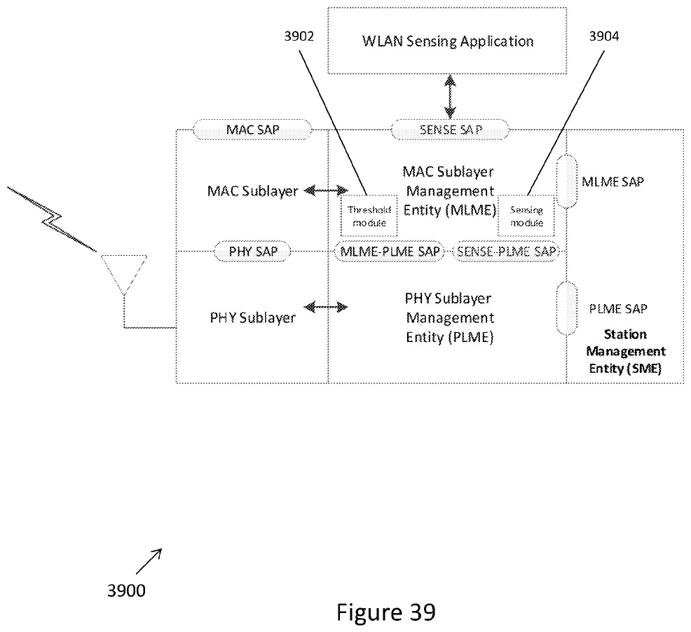

FIG. 39 depicts a schematic diagram for a receiver 3900 in accordance with various embodiments. The receiver 3900 may be configured to communicate with a transmitter for sensing measurements and may comprise a threshold module 3902 that may be configured to calculate a threshold for threshold based sensing. The threshold module 3902 may also calculate normalized channel measurement for WLAN Sensing. The receiver 3900 may further comprise a sensing module 3904 that may be configured to perform opportunistic sensing. The sensing module 3904 may have an inbuilt memory of its own that may be used to store the PPDU formats and relevant information for performing channel measurement, such that channel measurement can be performed by the receiver 3900 without any indication from or involvement of the transmitter.

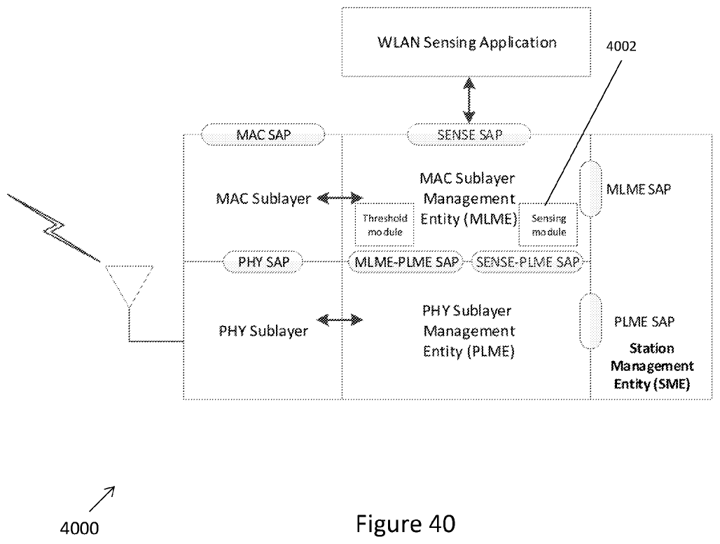

FIG. 40 depicts a schematic diagram for a transmitter 4000 in accordance with various embodiments. The transmitter 4000 may be configured to communicate with a receiver for sensing measurements and may comprise a sensing module 4002 that may be configured to track changes in Tx parameters and provide an appropriate indication to a receiver during a sensing session, for example receiver 3900.

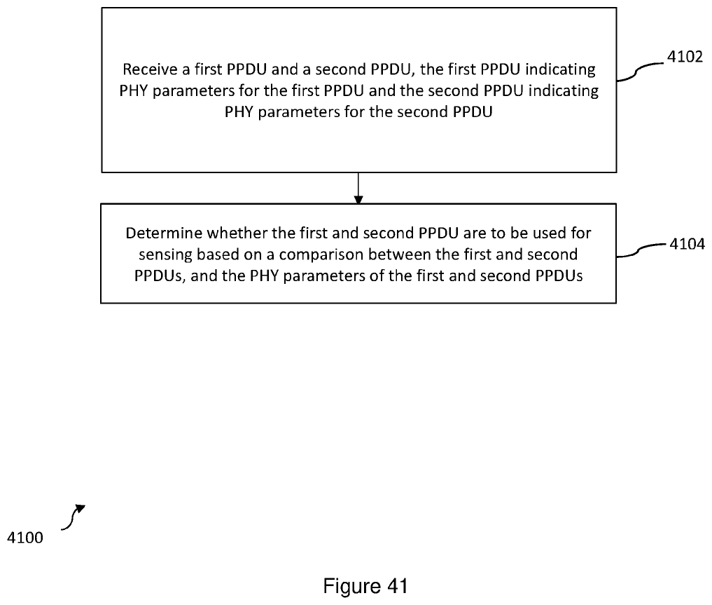

FIG. 41 shows a flow diagram 4100 illustrating a communication method according to various embodiments. At step 4104, a first PPDU and a second PPDU are received, the first PPDU indicating PHY parameters for the first PPDU and the second PPDU indicating PHY parameters for the second PPDU. At step 4104, it is determined whether the first and second PPDU are to be used for sensing based on a comparison between the first and second PPDUs, and the PHY parameters of the first and second PPDUs.

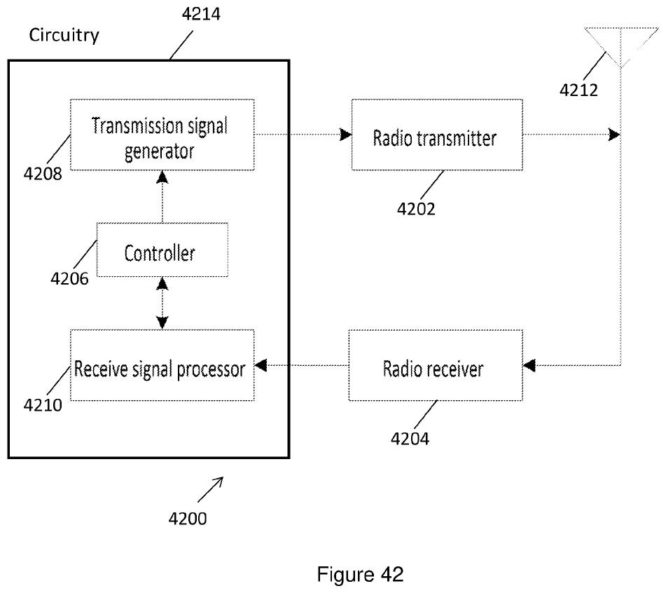

FIG. 42 shows a schematic, partially sectioned view of a communication apparatus 4200 that can be implemented for opportunistic WLAN sensing in accordance with the first to fifth embodiments. The communication apparatus 4200 may be implemented as an STA or AP according to various embodiments.

Various functions and operations of the communication apparatus 4200 are arranged into layers in accordance with a hierarchical model. In the model, lower layers report to higher layers and receive instructions therefrom in accordance with IEEE specifications. For the sake of simplicity, details of the hierarchical model are not discussed in the present disclosure.

As shown in FIG. 42, the communication apparatus 4200 may include circuitry 4214, at least one radio transmitter 4202, at least one radio receiver 4204 and multiple antennas 4212 (for the sake of simplicity, only one antenna is depicted in FIG. 42 for illustration purposes). The circuitry may include at least one controller 4206 for use in software and hardware aided execution of tasks it is designed to perform, including control of communications with one or more other devices in a wireless network. The at least one controller 4206 may control at least one transmission signal generator 4208 for generating frames to be sent through the at least one radio transmitter 4202 to one or more other STAs or APs and at least one receive signal processor 4210 for processing frames received through the at least one radio receiver 4204 from the one or more other STAs or APs. The at least one transmission signal generator 4208 and the at least one receive signal processor 4210 may be stand-alone modules of the communication apparatus 4200 that communicate with the at least one controller 4206 for the above-mentioned functions. Alternatively, the at least one transmission signal generator 4208 and the at least one receive signal processor 4210 may be included in the at least one controller 4206. It is appreciable to those skilled in the art that the arrangement of these functional modules is flexible and may vary depending on the practical needs and/or requirements. The data processing, storage and other relevant control apparatus can be provided on an appropriate circuit board and/or in chipsets.

In various embodiments, when in operation, the at least one radio transmitter 4202, at least one radio receiver 4204, and at least one antenna 4212 may be controlled by the at least one controller 4206. Furthermore, while only one radio transmitter 4202 is shown, it will be appreciated that there can be more than one of such transmitters.

In various embodiments, when in operation, the at least one radio receiver 4204, together with the at least one receive signal processor 4210, forms a receiver of the communication apparatus 4200. The receiver of the communication apparatus 4200, when in operation, provides functions required for sensing operations. While only one radio receiver 4204 is shown, it will be appreciated that there can be more than one of such receivers.

The communication apparatus 4200, when in operation, provides functions required for opportunistic WLAN sensing. For example, the communication apparatus 4200 may be a first communication apparatus. The receiver 4204 may, in operation, receive a first PPDU and a second PPDU, the first PPDU indicating PHY parameters for the first PPDU and the second PPDU indicating PHY parameters for the second PPDU. The circuitry 4214 may, in operation, determine whether the PHY parameters of the first and second PPDU are to be used for sensing based on a comparison between the first and second PPDUs, and the PHY parameters of the first and second PPDUs.

The receiver 4204 may be further configured to receive the first PPDU at a first time period and the second PPDU at a second time period, the second time period being after the first time period, and wherein the circuitry 4214 may be further configured to use the second PPDU for sensing based on a determination that the first PPDU and the second PPDU have a same PPDU format. The receiver 4204 may be further configured to receive the first PPDU at a first time period and the second PPDU at a second time period, the second time period being after the first time period, and wherein the circuitry 4214 may be further configured to save the PHY parameters of the first PPDU and extract a CSI of the second PPDU if the second PPDU has the same PHY parameters as that of the first PPDU. The first PPDU may further indicate transmit parameters for the first PPDU and the second PPDU may further indicate transmit parameters for the second PPDU, wherein the transmit parameters of the PPDUs comprise at least one of a Q-matrix, received transmit (Tx) power, Received Signal Strength Indicator (RSSI), number of long training fields (LTFs), and number of spatial streams.

The circuitry 4214 may be further configured to determine a benchmark PPDU based on PPDU format or the PHY parameters comprising number of LTFs, number of spatial streams and RSSI. The first PPDU may be the benchmark PPDU, and wherein the circuitry 4214 may be further configured to store information relating to the benchmark PPDU, compare a PPDU format of the second PPDU with the stored information, and determine whether to perform channel measurements based on the comparison. The stored information may comprise CSI matrix, number of spatial streams, number of transmit antennas, bandwidth and RSSI relating to the benchmark PPDU. The second PPDU may further comprise a CSI matrix, wherein the circuitry 4214 may be further configured to calculate a rank of the stored CSI matrix from the benchmark PPDU, and compare a rank of the CSI matrix of the second PPDU with the calculated rank of the stored CSI matrix. The circuitry 4214 may be further configured to forward the CSI matrix of the second PPDU to an upper layer if the comparison indicates that the rank of the stored CSI matrix and the rank of the CSI matrix of the second PPDU are the same.

The first communication apparatus 4200 may be further configured to perform channel measurement with a second communication apparatus, wherein the channel measurement may be based on a PPDU that is transmitted from the second communication apparatus to a third communication apparatus. The first communication apparatus may be further configured to perform channel measurement based on a periodic transmission transmitted from a second communication apparatus.

Further, the communication apparatus 4200 may be a second communication apparatus. The circuitry 4214 may, in operation, generate a PPDU indicating a change in transmit parameters. The transmitter 4202 may, in operation, transmit the PPDU to a first communication apparatus for performing channel measurement based on the PPDU and the indicated change in transmit parameters.

The transmitter 4202 may be further configured to transmit another PPDU indicating actual transmit parameters to the first communication apparatus, wherein the channel measurement may be based on the actual transmit parameters and the indicated change in transmit parameters. The circuitry 4214 may be further configured to set another PPDU as a non-beamformed PPDU. The circuitry 4214 may be further configured to store a null data packet (NDP) format during a threshold calculation phase, and the transmitter 4202 may be further configured to transmit a NDP having a same NDP format as the stored NDP format for a sensing session to the first communication apparatus. The PPDU may indicate the change in transmit parameter in a medium access control (MAC) header of the PPDU.

The present disclosure can be realized by software, hardware, or software in cooperation with hardware. Each functional block used in the description of each embodiment described above can be partly or entirely realized by an LSI such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra-LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

A non-limiting example of a station may be one included in a first plurality of stations affiliated with a multi-link station logical entity (i.e. such as an MLD), wherein as a part of the first plurality of stations affiliated with the multi-link station logical entity, stations of the first plurality of stations share a common medium access control (MAC) data service interface to an upper layer, wherein the common MAC data service interface is associated with a common MAC address or a Traffic Identifier (TID).

Thus, it can be seen that the present embodiments provide communication devices and methods for opportunistic WLAN sensing.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1. A first communication apparatus comprising:
a receiver, which in operation, receives a first PPDU and a second PPDU, the first PPDU indicating PHY parameters for the first PPDU and the second PPDU indicating PHY parameters for the second PPDU; and
circuitry, which in operation, determines whether the PHY parameters of the first and second PPDUs are to be used for sensing based on a comparison between the first and second PPDUs, and the PHY parameters of the first and second PPDUs.

2. The first communication apparatus according to claim 1, wherein the receiver is further configured to receive the first PPDU at a first time period and the second PPDU at a second time period, the second time period being after the first time period, and wherein the circuitry is further configured to use the second PPDU for sensing based on a determination that the first PPDU and the second PPDU have a same PPDU format.

3. The first communication apparatus according to claim 1, wherein the receiver is further configured to receive first PPDU at a first time period and the second PPDU at a second time period, the second time period being after the first time period, and wherein the circuitry is further configured to save the PHY parameters of the first PPDU and extract a CSI of the second PPDU if the second PPDU has the same PHY parameters as that of the first PPDU.

4. The first communication apparatus according to claim 1, wherein the first PPDU further indicates transmit parameters for the first PPDU and the second PPDU further indicates transmit parameters for the second PPDU, wherein the transmit parameters of the PPDUs comprise at least one of a Q-matrix, received transmit (Tx) power, Received Signal Strength Indicator (RSSI), number of long training fields (LTFs), and number of spatial streams.

5. The first communication apparatus according to claim 1, wherein the circuitry is further configured to determine a benchmark PPDU based on PPDU format or the PHY parameters comprising number of LTFs, number of spatial streams and RSSI.

6. The first communication apparatus according to claim 5, wherein the first PPDU is the benchmark PPDU, and wherein the circuitry is further configured to store information relating to the benchmark PPDU, compare a PPDU format of the second PPDU with the stored information, and determine whether to perform channel measurements based on the comparison.

7. The first communication apparatus according to claim 6, wherein the stored information comprises CSI matrix, number of spatial streams, number of transmit antennas, bandwidth and RSSI relating to the benchmark PPDU.

8. The first communication apparatus according to claim 7, wherein the second PPDU further comprises a CSI matrix, wherein the circuitry is further configured to calculate a rank of the stored CSI matrix from the benchmark PPDU, and compares a rank of the CSI matrix of the second PPDU with the calculated rank of the stored CSI matrix.

9. The first communication apparatus according to claim 8, wherein the circuitry is further configured to forward the CSI matrix of the second PPDU to an upper layer if the comparison indicates that the rank of the stored CSI matrix and the rank of the CSI matrix of the second PPDU are the same.

10. The first communication apparatus according to claim 1, further configured to perform channel measurement with a second communication apparatus, wherein the channel measurement is based on a PPDU that is transmitted from the second communication apparatus to a third communication apparatus.

11. The first communication apparatus according to claim 1, further configured to perform channel measurement based on a periodic transmission transmitted from a second communication apparatus.

12. A second communication apparatus comprising:
circuitry, which in operation, generates a PPDU indicating a change in transmit parameters; and
a transmitter, which in operation, transmits the PPDU to a first communication apparatus for performing channel measurement based on the PPDU and the indicated change in transmit parameters.

13. The second communication apparatus according to claim 12, wherein the transmitter is further configured to transmit another PPDU indicating actual transmit parameters to the first communication apparatus, wherein the channel measurement is based on the actual transmit parameters and the indicated change in transmit parameters.

14. The second communication apparatus according to claim 13, wherein the circuitry is further configured to set the another PPDU as a non-beamformed PPDU.

15. The second communication apparatus according to claim 12, wherein the circuitry is further configured to store a null data packet (NDP) format during a threshold calculation phase, and the transmitter is further configured to transmit a NDP having a same NDP format as the stored NDP format for a sensing session to the first communication apparatus.

16. The second communication apparatus according to claim 12, wherein the PPDU indicates the change in transmit parameter in a medium access control (MAC) header of the PPDU.

17. A communication method comprising:
receiving a first PPDU and a second PPDU, the first PPDU indicating PHY parameters for the first PPDU and the second PPDU indicating PHY parameters for the second PPDU; and
determining whether the first and second PPDUs are to be used for sensing based on a comparison between the first and second PPDUs, and the PHY parameters of the first and second PPDUs.
